(19) United States
(12) Patent Application Publication
(10) Pub. No.: US 2020/0216078 A1
(43) Pub. Date: Jul. 9, 2020

(54) DRIVER ATTENTIVENESS DETECTION SYSTEM

(71) Applicant: eyeSight Mobile Technologies Ltd., Herzliya (IL)

(72) Inventor: Itay Katz, Los Angeles, CA (US)

(21) Appl. No.: 16/592,907

(22) Filed: Oct. 4, 2019

Related U.S. Application Data
(63) Continuation of application No. PCT/US2019/039356, filed on Jun. 26, 2019.
(60) Provisional application No. 62/690,309, filed on Jun. 26, 2018.
(60) Provisional application No. 62/757,298, filed on Nov. 8, 2018.
(60) Provisional application No. 62/834,471, filed on Apr. 16, 2019.

(51) Int. Cl. B60W 40/08; B60W 40/06; B60R 21/015; B60R 11/04; G06K 9/00

(52) U.S. Cl. CPC B60W 40/08; B60W 2556/10; B60R 21/01552; B60R 11/04; G06K 9/00845; G06K 9/00791; B60W 2540/229; B60W 2040/0827; B60W 2040/0872; B60W 2540/221; B60W 2540/22; B60W 2554/4048; B60W 2540/225; B60W 2554/802; B60W 2555/20; B60W 40/06

(57) ABSTRACT

Systems and methods are disclosed for contextual driver monitoring. In one implementation, one or more first inputs are received. The one or more first inputs are processed to identify a first object in relation to a vehicle. One or more second inputs are received. The one or more second inputs are processed to determine a state of attentiveness of a driver of the vehicle with respect to the first object based on (a) a direction of the gaze of the driver in relation to the first object and (b) one or more conditions under which the first object is perceived by the driver. One or more actions are initiated based on the state of attentiveness of a driver.

### CROSS-REFERENCE TO RELATED APPLICATIONS

This application is a continuation of PCT International Application No. PCT/US2019/039356, filed Jun. 26, 2019, which is related to and claims the benefit of priority to U.S. Patent Application No. 62/690,309 filed Jun. 26, 2018, U.S. Patent Application No. 62/757,298 filed Nov. 8, 2018, and U.S. Patent Application No. 62/834,471 filed Apr. 16, 2019, each of which is incorporated herein by reference in its entirety.

### TECHNICAL FIELD

Aspects and implementations of the present disclosure relate to data processing and, more specifically, but without limitation, to contextual driver monitoring.

### BACKGROUND

In order to operate a motor vehicle safely, the driver of such vehicle must focus his/her attention on the road or path being traveled. Periodically, the attention of the driver may change (e.g., when looking at the mirrors of the vehicle).

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates further aspects of an example system, in accordance with an example embodiment.

FIG. 3 depicts an example scenario described herein, in accordance with an example embodiment.

FIG. 4 is a flow chart illustrating a method, in accordance with an example embodiment, for contextual driver monitoring.

FIG. 5 is a flow chart illustrating a method, in accordance with an example embodiment, for contextual driver monitoring.

FIG. 6 is a flow chart illustrating a method, in accordance with an example embodiment, for contextual driver monitoring.

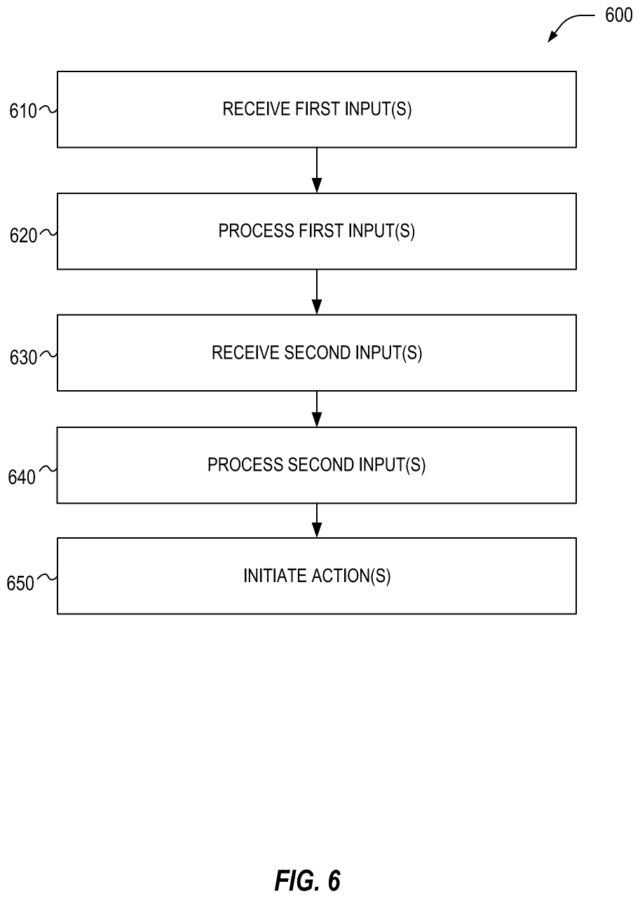

FIG. 7 is a flow chart illustrating a method, in accordance with an example embodiment, for contextual driver monitoring.

FIG. 8 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to contextual driver monitoring.

It can be appreciated that various eye-tracking techniques enable the determination of user gaze (e.g., the direction/location at which the eyes of a user are directed or focused). However, such techniques require that a correlation be identified/determined between the eye(s) of the user and another object. For example, in addition to a camera that perceives the eye(s) of the user, certain technologies utilize a second camera that is directed outwards (i.e., in the direction the user is looking). The images captured by the respective cameras (e.g., those reflecting the user gaze and those depicting the object at which the user is looking) then must be correlated. Alternatively, other solutions present the user with an icon, indicator, etc., at a known location/device. The user must then look at the referenced icon, at which point the calibration can be performed. However, both of the referenced solutions entail numerous shortcomings. For example, both solutions require additional hardware which may be expensive, difficult to install/configure, or otherwise infeasible.

Accordingly, described herein in various implementations are systems, methods, and related technologies for driver monitoring. As described herein, the disclosed technologies provide numerous advantages and improvements over existing solutions

It can therefore be appreciated that the described technologies are directed to and address specific technical challenges and longstanding deficiencies in multiple technical areas, including but not limited to image processing, eye tracking, and machine vision. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

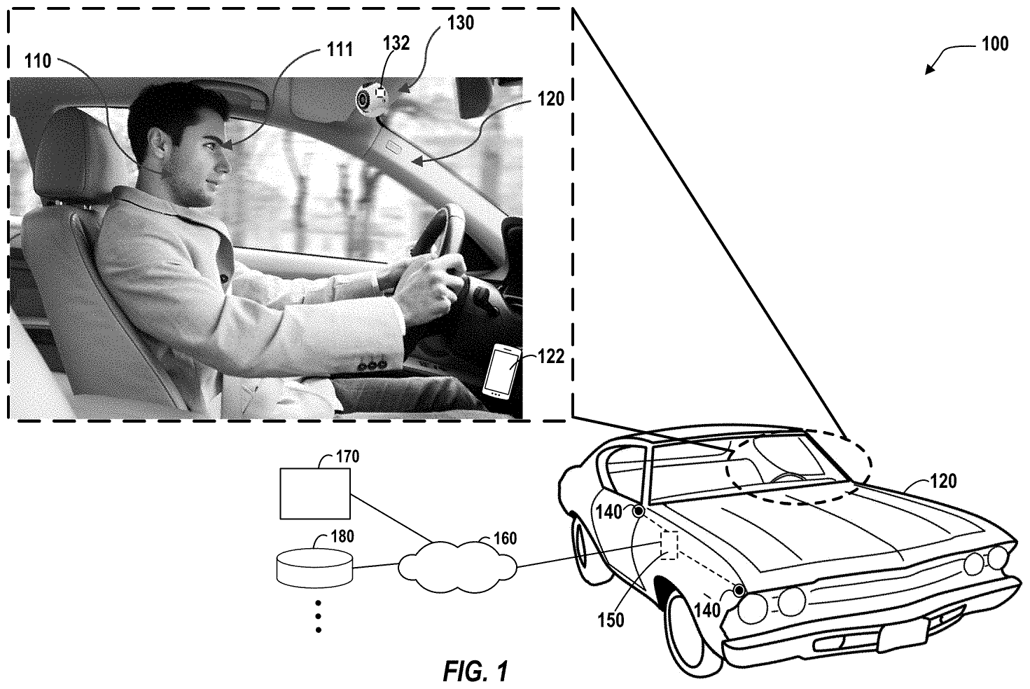

FIG. 1 illustrates an example system 100, in accordance with some implementations. As shown, the system 100 includes sensor 130 which can be an image acquisition device (e.g., a camera), image sensor, IR sensor, or any other sensor described herein. Sensor 130 can be positioned or oriented within vehicle 120 (e.g., a car, bus, airplane, flying vehicle or any other such vehicle used for transportation). In certain implementations, sensor 130 can include or otherwise integrate one or more processor(s) 132 that process image(s) and/or other such content captured by the sensor. In other implementations, sensor 130 can be configured to connect and/or otherwise communicate with other device(s) (as described herein), and such devices can receive and process the referenced image(s).

Vehicle may include a self-driving vehicle, autonomous vehicle, semi-autonomous vehicle; vehicles traveling on the ground include cars, buses, trucks, trains, army-related vehicles; flying vehicles, including but not limited to airplanes, helicopters, drones, flying “cars”/taxis, semi-autonomous flying vehicles; vehicles with or without motors including bicycles, quadcopter, personal vehicle or non-personal vehicle; ships, any marine vehicle including but not limited to a ship, a yacht, a ski-jet, submarine.

Sensor 130 (e.g., a camera) may include, for example, a CCD image sensor, a CMOS image sensor, a light sensor, an IR sensor, an ultrasonic sensor, a proximity sensor, a shortwave infrared (SWIR) image sensor, a reflectivity sensor, an RGB camera, a black and white camera, or any other device that is capable of sensing visual characteristics of an environment. Moreover, sensor 130 may include, for example, a single photosensor or 1-D line sensor capable of scanning an area, a 2-D sensor, or a stereoscopic sensor that includes, for example, a plurality of 2-D image sensors. In certain implementations, a camera, for example, may be associated with a lens for focusing a particular area of light onto an image sensor. The lens can be narrow or wide. A wide lens may be used to get a wide field-of-view, but this may require a high-resolution sensor to get a good recognition distance. Alternatively, two sensors may be used with narrower lenses that have an overlapping field of view; together, they provide a wide field of view, but the cost of two such sensors may be lower than a high-resolution sensor and a wide lens.

Sensor 130 may view or perceive, for example, a conical or pyramidal volume of space. Sensor 130 may have a fixed position (e.g., within vehicle 120). Images captured by sensor 130 may be digitized and input to the at least one processor 132, or may be input to the at least one processor 132 in analog form and digitized by the at least one processor.

It should be noted that sensor 130 as depicted in FIG. 1, as well as the various other sensors depicted in other figures and described and/or referenced herein may include, for example, an image sensor configured to obtain images of a three-dimensional (3-D) viewing space. The image sensor may include any image acquisition device including, for example, one or more of a camera, a light sensor, an infrared (IR) sensor, an ultrasonic sensor, a proximity sensor, a CMOS image sensor, a shortwave infrared (SWIR) image sensor, or a reflectivity sensor, a single photosensor or 1-D line sensor capable of scanning an area, a CCD image sensor, a reflectivity sensor, a depth video system comprising a 3-D image sensor or two or more two-dimensional (2-D) stereoscopic image sensors, and any other device that is capable of sensing visual characteristics of an environment. A user or other element situated in the viewing space of the sensor(s) may appear in images obtained by the sensor(s). The sensor(s) may output 2-D or 3-D monochrome, color, or IR video to a processing unit, which may be integrated with the sensor(s) or connected to the sensor(s) by a wired or wireless communication channel.

The at least one processor 132 as depicted in FIG. 1, as well as the various other processor(s) depicted in other figures and described and/or referenced herein may include, for example, an electric circuit that performs a logic operation on an input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA), an application-specific integrated circuit (ASIC), or any other circuit suitable for executing instructions or performing logic operations. The at least one processor may be coincident with or may constitute any part of a processing unit such as a processing unit which may include, among other things, a processor and memory that may be used for storing images obtained by the image sensor. The processing unit may include, among other things, a processor and memory that may be used for storing images obtained by the sensor(s). The processing unit and/or the processor may be configured to execute one or more instructions that reside in the processor and/or the memory. Such a memory (e.g., memory 1230 as shown in FIG. 12) may include, for example, persistent memory, ROM, EEPROM, EAROM, SRAM, DRAM, DDR SDRAM, flash memory devices, magnetic disks, magneto optical disks, CD-ROM, DVD-ROM, Blu-ray, and the like, and may contain instructions (i.e., software or firmware) or other data. Generally, the at least one processor may receive instructions and data stored by memory. Thus, in some embodiments, the at least one processor executes the software or firmware to perform functions by operating on input data and generating output. However, the at least one processor may also be, for example, dedicated hardware or an application-specific integrated circuit (ASIC) that performs processes by operating on input data and generating output. The at least one processor may be any combination of dedicated hardware, one or more ASICs, one or more general purpose processors, one or more DSPs, one or more GPUs, or one or more other processors capable of processing digital information.

Images captured by sensor 130 may be digitized by sensor 130 and input to processor 132, or may be input to processor 132 in analog form and digitized by processor 132. A sensor can be a proximity sensor. Example proximity sensors may include, among other things, one or more of a capacitive sensor, a capacitive displacement sensor, a laser rangefinder, a sensor that uses time-of-flight (TOF) technology, an IR sensor, a sensor that detects magnetic distortion, or any other sensor that is capable of generating information indicative of the presence of an object in proximity to the proximity sensor. In some embodiments, the information generated by a proximity sensor may include a distance of the object to the proximity sensor. A proximity sensor may be a single sensor or may be a set of sensors. Although a single sensor 130 is illustrated in FIG. 1, system 100 may include multiple types of sensors and/or multiple sensors of the same type. For example, multiple sensors may be disposed within a single device such as a data input device housing some or all components of system 100, in a single device external to other components of system 100, or in various other configurations having at least one external sensor and at least one sensor built into another component (e.g., processor 132 or a display) of system 100.

Processor 132 may be connected to or integrated within sensor 130 via one or more wired or wireless communication links, and may receive data from sensor 130 such as images, or any data capable of being collected by sensor 130, such as is described herein. Such sensor data can include, for example, sensor data of a user's head, eyes, face, etc. Images may include one or more of an analog image captured by sensor 130, a digital image captured or determined by sensor 130, a subset of the digital or analog image captured by sensor 130, digital information further processed by processor 132, a mathematical representation or transformation of information associated with data sensed by sensor 130, information presented as visual information such as frequency data representing the image, conceptual information such as presence of objects in the field of view of the sensor, etc. Images may also include information indicative the state of the sensor and or its parameters during capturing images e.g. exposure, frame rate, resolution of the image, color bit resolution, depth resolution, field of view of sensor 130, including information from other sensor(s) during the capturing of an image, e.g. proximity sensor information, acceleration sensor (e.g., accelerometer) information, information describing further processing that took place further to capture the image, illumination condition during capturing images, features extracted from a digital image by sensor 130, or any other information associated with sensor data sensed by sensor 130. Moreover, the referenced images may include information associated with static images, motion images (i.e., video), or any other visual-based data. In certain implementations, sensor data received from one or more sensor(s) 130 may include motion data, GPS location coordinates and/or direction vectors, eye gaze information, sound data, and any data types measurable by various sensor types. Additionally, in certain implementations, sensor data may include metrics obtained by analyzing combinations of data from two or more sensors.

In certain implementations, processor 132 may receive data from a plurality of sensors via one or more wired or wireless communication links. In certain implementations, processor 132 may also be connected to a display, and may send instructions to the display for displaying one or more images, such as those described and/or referenced herein. It should be understood that in various implementations the described, sensor(s), processor(s), and display(s) may be incorporated within a single device, or distributed across multiple devices having various combinations of the sensor(s), processor(s), and display(s).

As noted above, in certain implementations, in order to reduce data transfer from the sensor to an embedded device motherboard, processor, application processor, GPU, a processor controlled by the application processor, or any other processor, the system may be partially or completely integrated into the sensor. In the case where only partial integration to the sensor, ISP or sensor module takes place, image preprocessing, which extracts an object's features (e.g., related to a predefined object), may be integrated as part of the sensor, ISP or sensor module. A mathematical representation of the video/image and/or the object's features may be transferred for further processing on an external CPU via dedicated wire connection or bus. In the case that the whole system is integrated into the sensor, ISP or sensor module, a message or command (including, for example, the messages and commands referenced herein) may be sent to an external CPU. Moreover, in some embodiments, if the system incorporates a stereoscopic image sensor, a depth map of the environment may be created by image preprocessing of the video/image in the 2D image sensors or image sensor ISPs and the mathematical representation of the video/image, object's features, and/or other reduced information may be further processed in an external CPU.

As shown in FIG. 1, sensor 130 can be positioned to capture or otherwise receive image(s) or other such inputs of user 110 (e.g., a human user who may be the driver or operator of vehicle 120). Such image(s) can be captured in different frame rates (FPS)). As described herein, such image(s) can reflect, for example, various physiological characteristics or aspects of user 110, including but not limited to the position of the dead of the user, the gaze or direction of eye(s) 111 of user 110, the position (location in space) and orientation of the face of user 110, etc. In one example, the system can be configured to capture the images in different exposure rates for detecting the user gaze. In another example, the system can alter or adjust the FPS of the captured images for detecting the user gaze. In another example, the system can alter or adjust the exposure and/or frame rate in relation to detecting the user wearing glasses and/or the type of glasses (sight glasses, sunglasses, etc.).

It should be understood that the scenario depicted in FIG. 1 is provided by way of example. Accordingly, the described technologies can also be configured or implemented in various other arrangements, configurations, etc. For example, sensor 130 can be positioned or located in any number of other locations (e.g., within vehicle 120). For example, in certain implementations sensor 130 can be located above user 110, in front of the user 110 (e.g., positioned on or integrated within the dashboard of vehicle 110), to the side to of user 110 (such that the eye of the user is visible/viewable to the sensor from the side, which can be advantageous and overcome challenges caused by users who wear glasses), and in any number of other positions/locations. Additionally, in certain implementations the described technologies can be implemented using multiple sensors (which may be arranged in different locations).

In certain implementations, images, videos, and/or other inputs can be captured/received at sensor 130 and processed (e.g., using face detection techniques) to detect the presence of eye(s) 111 of user 110. Upon detecting the eye(s) of the user, the gaze of the user can be determined (e.g., via a neural network and/or utilizing one or more machine learning techniques). In certain implementations, the gaze of the user can be determined using information such as the position of sensor 130 within vehicle 120. In other implementations, the gaze of the user can be further determined using additional information such as the location of the face of user 110 within the vehicle (which may vary based on the height of the user), user age, gender, face structure, inputs from other sensors including camera(s) positioned in different places in the vehicle, sensors that provide 3D information of the face of the user (such as TOF sensors), IR sensors, physical sensors (such as a pressure sensor located within a seat of a vehicle), proximity sensor, etc. In other implementations, the gaze or gaze direction of the user can be identified, determined, or extracted by other devices, systems, etc. (e.g., via a neural network and/or utilizing one or more machine learning techniques) and transmitted/provided to the described system. Upon detecting/determining the gaze of the user, various features of eye(s) 111 of user 110 can be further extracted, as described herein.

Various aspects of the disclosed system(s) and related technologies can include or involve machine learning. Machine learning can include one or more techniques, algorithms, and/or models (e.g., mathematical models) implemented and running on a processing device. The models that are implemented in a machine learning system can enable the system to learn and improve from data based on its statistical characteristics rather on predefined rules of human experts. Machine learning focuses on the development of computer programs that can access data and use it to learn for themselves to perform a certain task.

Machine learning models may be shaped according to the structure of the machine learning system, supervised or unsupervised, the flow of data within the system, the input data and external triggers.

Machine learning can be related as an application of artificial intelligence (AI) that provides systems the ability to automatically learn and improve from data input without being explicitly programmed.

Machine learning may apply to various tasks, such as feature learning, sparse dictionary learning, anomaly detection, association rule learning, and collaborative filtering for recommendation systems. Machine learning may be used for feature extraction, dimensionality reduction, clustering, classifications, regression, or metric learning. Machine learning systems may be supervised and semi-supervised, unsupervised, reinforced. Machine learning system may be implemented in various ways including linear and logistic regression, linear discriminant analysis, support vector machines (SVM), decision trees, random forests, ferns, Bayesian networks, boosting, genetic algorithms, simulated annealing, or convolutional neural networks (CNN).

Deep learning is a special implementation of a machine learning system. In one example, deep learning algorithms discover multiple levels of representation, or a hierarchy of features, with higher-level, more abstract features extracted using lower-level features. Deep learning may be implemented in various feedforward or recurrent architectures including multi-layered perceptrons, convolutional neural networks, deep neural networks, deep belief networks, autoencoders, long short term memory (LSTM) networks, generative adversarial networks, and deep reinforcement networks.

The architectures mentioned above are not mutually exclusive and can be combined or used as building blocks for implementing other types of deep networks. For example, deep belief networks may be implemented using autoencoders. In turn, autoencoders may be implemented using multi-layered perceptrons or convolutional neural networks.

Training of a deep neural network may be cast as an optimization problem that involves minimizing a predefined objective (loss) function, which is a function of networks parameters, its actual prediction, and desired prediction. The goal is to minimize the differences between the actual prediction and the desired prediction by adjusting the network's parameters. Many implementations of such an optimization process are based on the stochastic gradient descent method which can be implemented using the back-propagation algorithm. However, for some operating regimes, such as in online learning scenarios, stochastic gradient descent have various shortcomings and other optimization methods have been proposed.

Deep neural networks may be used for predicting various human traits, behavior and actions from input sensor data such as still images, videos, sound and speech.

In another implementation example, a deep recurrent LSTM network is used to anticipate driver's behavior or action few seconds before it happens, based on a collection of sensor data such as video, tactile sensors and GPS.

In some embodiments, the processor may be configured to implement one or more machine learning techniques and algorithms to facilitate detection/prediction of user behavior-related variables. The term “machine learning” is non-limiting, and may include techniques including, but not limited to, computer vision learning, deep machine learning, deep learning, and deep neural networks, neural networks, artificial intelligence, and online learning, i.e. learning during operation of the system. Machine learning algorithms may detect one or more patterns in collected sensor data, such as image data, proximity sensor data, and data from other types of sensors disclosed herein. A machine learning component implemented by the processor may be trained using one or more training data sets based on correlations between collected sensor data or saved data and user behavior related variables of interest. Save data may include data generated by other machine learning system, preprocessing analysis on sensors input, data associated with the object that is observed by the system. Machine learning components may be continuously or periodically updated based on new training data sets and feedback loops.

Machine learning components can be used to detect or predict gestures, motion, body posture, features associated with user alertness, driver alertness, fatigue, attentiveness to the road, distraction, features associated with expressions or emotions of a user, features associated with gaze direction of a user, driver or passenger. Machine learning components can be used to detect or predict actions including talking, shouting, singing, driving, sleeping, resting, smoking, reading, texting, holding a mobile device, holding a mobile device against the cheek, holding a device by hand for texting or speaker calling, watching content, playing a digital game, using a head mount device such as smart glasses, VR, AR, device learning, interacting with devices within a vehicle, fixing the safety belt, wearing a seat belt, wearing seatbelt incorrectly, opening a window, getting in or out of the vehicle, picking an object, looking for an object, interacting with other passengers, fixing the glasses, fixing/putting eyes contacts, fixing the hair/dress, putting lips stick, dressing or undressing, involvement in sexual activities, involvement in violent activity, looking at a mirror, communicating with another one or more persons/systems/AIs using digital device, features associated with user behavior, interaction with the environment, interaction with another person, activity, emotional state, emotional responses to: content, event, trigger another person, one or more object, learning the vehicle interior.

Machine learning components can be used to detect facial attributes including head pose, gaze, face and facial attributes 3D location, facial expression, facial landmarks including: mouth, eyes, neck, nose, eyelids, iris, pupil, accessories including: glasses/sunglasses, earrings, makeup; facial actions including: talking, yawning, blinking, pupil dilation, being surprised; occluding the face with other body parts (such as hand, fingers), with other object held by the user (a cap, food, phone), by other person (other person hand) or object (part of the vehicle), user unique expressions (such as Tourette's Syndrome related expressions).

Machine learning systems may use input from one or more systems in the vehicle, including ADAS, car speed measurement, left/right turn signals, steering wheel movements and location, wheel directions, car motion path, input indicating the surrounding around the car, SFM and 3D reconstruction.

Machine learning components can be used to detect the occupancy of a vehicle's cabin, detecting and tracking people and objects, and acts according to their presence, position, pose, identity, age, gender, physical dimensions, state, emotion, health, head pose, gaze, gestures, facial features and expressions. Machine learning components can be used to detect one or more person, person recognition/age/gender, person ethnicity, person height, person weight, pregnancy state, posture, out-of-position (e.g. legs up, lying down, etc.), seat validity (availability of seatbelt), person skeleton posture, seat belt fitting, an object, animal presence in the vehicle, one or more objects in the vehicle, learning the vehicle interior, an anomaly, child/baby seat in the vehicle, number of persons in the vehicle, too many persons in a vehicle (e.g. 4 children in rear seat, while only 3 allowed), person sitting on other person's lap.

Machine learning components can be used to detect or predict features associated with user behavior, action, interaction with the environment, interaction with another person, activity, emotional state, emotional responses to: content, event, trigger another person, one or more object, detecting child presence in the car after all adults left the car, monitoring back-seat of a vehicle, identifying aggressive behavior, vandalism, vomiting, physical or mental distress, detecting actions such as smoking, eating and drinking, understanding the intention of the user through their gaze or other body features.

It should be understood that the ‘gaze of a user,’ ‘eye gaze,’ etc., as described and/or referenced herein, can refer to the manner in which the eye(s) of a human user are positioned/focused. For example, the ‘gaze’ or ‘eye gaze’ of user 110 can refer to the direction towards which eye(s) 111 of user 110 are directed or focused e.g., at a particular instance and/or over a period of time. By way of further example, the ‘gaze of a user’ can be or refer to the location the user looks at a particular moment. By way of yet further example, the ‘gaze of a user’ can be or refer to the direction the user looks at a particular moment.

Moreover, in certain implementations the described technologies can determine/extract the referenced gaze of a user using various techniques (e.g., via a neural network and/or utilizing one or more machine learning techniques). For example, in certain implementations a sensor (e.g., an image sensor, camera, IR camera, etc.) can capture image(s) of eye(s) (e.g., one or both human eyes). Such image(s) can then be processed, e.g., to extract various features such as the pupil contour of the eye, reflections of the IR sources (e.g., glints), etc. The gaze or gaze vector(s) can then be computed/output, indicating the eyes' gaze points (which can correspond to a particular direction, location, object, etc.).

Additionally, in certain implementations the described technologies can compute, determine, etc., that gaze of the user is directed towards (or is likely to be directed towards) a particular item, object, etc., e.g., under certain circumstances. For example, as described herein, in a scenario in which a user is determined to be driving straight on a highway, it can be determined that the gaze of user 110 as shown in FIG. 1 is directed towards (or is likely to be directed towards) the road ahead/horizon. It should be understood that ‘looking towards the road ahead’ as referenced here can refer to a user such as a driver of a vehicle whose gaze/focus is directed/aligned towards the road/path visible through the front windshield of the vehicle being driven (when driving in a forward direction).

Further aspects of the described system are depicted in various figures. For example, FIG. 1 depicts aspects of extracting, determining, etc. the eye gaze of a user (e.g., a driver of a car), e.g., using information that may include the position of the camera in the car, the location of the user face in the car (which can vary widely according the user height), user age, gender, face structure, etc., as described herein. As shown in FIG. 1, driver 110 can be seated in car 120 (it should be understood that the described system can be similarly employed with respect to practically any vehicle, e.g., bus, etc.), and the gaze/position of the eyes of the user position can be determined based on images captured by camera 130 as positioned within the car. It should also be noted that ‘car’ as used herein can refer to practically any motor vehicle used for transportation, such as a wheeled, self-powered motor vehicle, flying vehicle, etc.

In other scenarios, the described technologies can determine that the gaze of user 110 as shown in FIG. 1 is directed towards (or is likely to be directed towards) an object, such as an object (e.g., road sign, vehicle, landmark, etc.) positioned outside the vehicle. In certain implementations, such an object can be identified based on inputs originating from one or more sensors embedded within the vehicle and/or from information originating from other sources.

In yet other scenarios, the described technologies can determine various state(s) of the user (e.g., the driver of a vehicle). Such state(s) can include or reflect aspects or characteristics associated with the attentiveness or awareness of the driver. In certain implementations, such state(s) can correspond to object(s), such as objects inside or outside the vehicle (e.g., other passengers, road signs, landmarks, other vehicles, etc.).

In some implementations, processor 132 is configured to initiate various action(s), such as those associated with aspects, characteristics, phenomena, etc. identified within captured or received images. The action performed by the processor may be, for example, generation of a message or execution of a command (which may be associated with detected aspect, characteristic, phenomenon, etc.). For example, the generated message or command may be addressed to any type of destination including, but not limited to, an operating system, one or more services, one or more applications, one or more devices, one or more remote applications, one or more remote services, or one or more remote devices.

It should be noted that, as used herein, a ‘command’ and/or ‘message’ can refer to instructions and/or content directed to and/or capable of being received/processed by any type of destination including, but not limited to, one or more of: operating system, one or more services, one or more applications, one or more devices, one or more remote applications, one or more remote services, or one or more remote devices.

It should also be understood that the various components referenced herein can be combined together or separated into further components, according to a particular implementation. Additionally, in some implementations, various components may run or be embodied on separate machines. Moreover, some operations of certain of the components are described and illustrated in more detail herein.

The presently disclosed subject matter can also be configured to enable communication with an external device or website, such as in response to a selection of a graphical (or other) element. Such communication can include sending a message to an application running on the external device, a service running on the external device, an operating system running on the external device, a process running on the external device, one or more applications running on a processor of the external device, a software program running in the background of the external device, or to one or more services running on the external device. Additionally, in certain implementations a message can be sent to an application running on the device, a service running on the device, an operating system running on the device, a process running on the device, one or more applications running on a processor of the device, a software program running in the background of the device, or to one or more services running on the device. In certain implementations the device is embedded inside or outside the vehicle.

“Image information,” as used herein, may be one or more of an analog image captured by sensor 130, a digital image captured or determined by sensor 130, subset of the digital or analog image captured by sensor 130, digital information further processed by an ISP, a mathematical representation or transformation of information associated with data sensed by sensor 130, frequencies in the image captured by sensor 130, conceptual information such as presence of objects in the field of view of sensor 130, information indicative of the state of the image sensor or its parameters when capturing an image (e.g., exposure, frame rate, resolution of the image, color bit resolution, depth resolution, or field of view of the image sensor), information from other sensors when sensor 130 is capturing an image (e.g. proximity sensor information, or accelerometer information), information describing further processing that took place after an image was captured, illumination conditions when an image is captured, features extracted from a digital image by sensor 130, or any other information associated with data sensed by sensor 130. Moreover, “image information” may include information associated with static images, motion images (i.e., video), or any other information captured by the image sensor.

In addition to sensor 130, one or more sensor(s) 140 can be integrated within or otherwise configured with respect to the referenced vehicle. Such sensors can share various characteristics of sensor 130 (e.g., image sensors), as described herein. In certain implementations, the referenced sensor(s) 140 can be deployed in connection with an advanced driver-assistance system 150 (ADAS) or any other system(s) that aid a vehicle driver while driving. An ADAS can be, for example, systems that automate, adapt and enhance vehicle systems for safety and better driving. An ADAS can also alert the driver to potential problems and/or avoid collisions by implementing safeguards such as taking over control of the vehicle. In certain implementations, an ADAS can incorporate features such as lighting automation, adaptive cruise control and collision avoidance, alerting a driver to other cars or dangers, lane departure warnings, automatic lane centering, showing what is in blind spots, and/or connecting to smartphones for navigation instructions.

By way of illustration, in one scenario sensor(s) 140 can identify various object(s) outside the vehicle (e.g., on or around the road on which the vehicle travels), while sensor 130 can identify phenomena occurring inside the vehicle (e.g., behavior of the driver/passenger(s), etc.). In various implementations, the content originating from the respective sensors 130, 140 can be processed at a single processor (e.g., processor 132) and/or at multiple processors (e.g., processor(s) incorporated as part of ADAS 150).

As described in further detail herein, the described technologies can be configured to utilize and/or account for information reflecting objects or phenomena present outside a vehicle together with information reflecting the state of the driver of the vehicle. In doing so, various determination(s) can be computed with respect to the attentiveness of a driver (e.g., via a neural network and/or utilizing one or more machine learning techniques). For example, in certain implementations the current attentiveness of a driver (e.g., at one or more intervals during a trip/drive) can be computed. In other implementations, various suggested and/or required degree(s) of attentiveness can be determined (e.g., that a driver must exhibit a certain degree of attentiveness at a particular interval or location in order to safely navigate the vehicle).

Objects, such as may be referred to herein as ‘first object(s),’ ‘second object(s),’ etc., can include road signs, traffic lights, moving vehicles, stopped vehicles, stopped vehicles on the side of the road, vehicles approaching a cross section or square, humans or animals walking/standing on the sidewalk or on the road or crossing the road, bicycle riders, a vehicle whose door is opened, a car stopped on the side of the road, a human walking or running along the road, a human working or standing on the road and/or signing (e.g. police officer or traffic related worker), a vehicle stopping, red lights of vehicle in the field of view of the driver, objects next to or on the road, landmarks, buildings, advertisements, objects that signal to the driver (such as that the lane is closed, cones located on the road, blinking lights etc.).

In certain implementations, the described technologies can be deployed as a driver assistance system. Such a system can be configured to detect the awareness of a driver and can further initiate various action(s) using information associated with various environmental/driving conditions.

For example, in certain implementations the referenced suggested and/or required degree(s) or level(s) of attentiveness can be reflected as one or more attentiveness threshold(s).

Such threshold(s) can be computed and/or adjusted to reflect the suggested or required attentiveness/awareness a driver is to have/exhibit in order to navigate a vehicle safely (e.g., based on/in view of environmental conditions, etc.). The threshold(s) can be further utilized to implement actions or responses, such as by providing stimuli to increase driver awareness (e.g., based on the level of driver awareness and/or environmental conditions). Additionally, in certain implementations a computed threshold can be adjusted based on various phenomena or conditions, e.g., changes in road conditions, changes in road structure, such as new exits or interchanges, as compared to previous instance(s) the driver drove in that road and/or in relation to the destination of the driver, driver attentiveness, lack of response by the driver to navigation system instruction(s) (e.g., the driver doesn't maneuver the vehicle in a manner consistent with following a navigation instruction), other behavior or occurrences, etc.

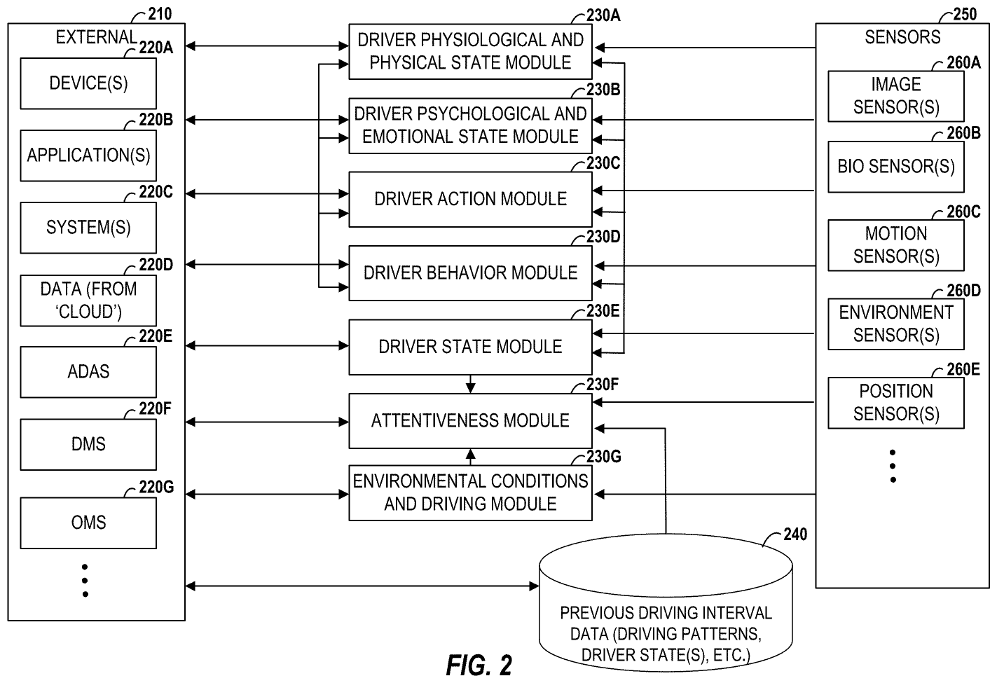

It should be noted that while, in certain scenarios it may be advantageous to provide various notifications, alerts, etc. to a user, in other scenarios providing too many alerts may be counterproductive (e.g., by conditioning the user to ignore such alerts or deactivate the system). Additionally, it can be appreciated that a single threshold may not be accurate or effective with respect to an individual/specific user. Accordingly, in certain implementations the described threshold(s) can be configured to be dynamic, thereby preventing alerts/notifications from being provided in scenarios in which the driver may not necessarily need them, while in other scenarios an alert which may be needed may not necessarily be provided to the driver (which may otherwise arise when a single, static threshold is used). FIG. 2 depicts further aspects of the described system. As shown in FIG. 2, the described technologies can include or incorporate various modules. For example, module 230A can determine physiological and/or physical state of a driver, module 230B can determine psychological or emotional state of a driver, module 230C can determine action(s) of a driver, module 230D can determine behavior(s) of a driver, each of which is described in detail herein. Driver state module can determine a state of a driver, as described in detail herein. Module 230F can determine the attentiveness of the driver, as described in detail herein. Module 230G can determine environmental conditions and/or driving, etc., as described herein.

In certain implementations, the module(s) can receive input(s) and/or provide output(s) to various externals devices, systems, resources, etc. 210, such as device(s) 220A, application(s) 220B, system(s) 220C, data (e.g., from the ‘cloud’) 220D, ADAS 220E, DMS 220F, OMS 220G, etc. Additionally, data (e.g., stored in repository 240) associated with previous driving intervals, driving patterns, driver states, etc., can also be utilized, as described herein. Additionally, in certain implementations the referenced modules can receive inputs from various sensors 250, such as image sensor(s) 260A, bio sensor(s) 260B, motion sensor(s) 260C, environment sensor(s) 260D, position sensor(s) 260E, and/or other sensors, as is described in detail herein.

The environmental conditions (utilized in determining aspects of the referenced attentiveness) can include but are not limited to: road conditions (e.g. sharp turns, limited or obstructed views of the road on which a driver is traveling, which may limit the ability of the driver to see vehicles or other objects approaching from the same side and/or the other side of the road due to turns or other phenomena, a narrow road, poor road conditions, sections of a road that on which accidents or other incidents occurred, etc.), weather conditions (e.g., rain, fog, winds, etc.).

in certain implementations, the described technologies can be configured to analyze road conditions to determine: a level or threshold of attention required in order for a driver to navigate safely. Additionally, in certain implementations the path of a road (reflecting curves, contours, etc. of the road) can be analyzed to determine (e.g., via a neural network and/or utilizing one or more machine learning techniques): a minimum/likelihood time duration or interval until a driver traveling on the road can first see a car traveling on the same side or another side of the road, a minimum time duration or interval until a driver traveling on the road can slow down/stop/maneuver to the side in a scenario in which a car traveling on the other side of the road is not driving in its lane, or a level of attention required for a driver to safely navigate a particular portion or segment of the road.

Additionally, in certain implementations the described technologies can be configured to analyze road paths such as sharp turns present at various points, portions, or segment of a road such as a segment of a road on which a driver is expected or determined to be likely to travel on in the future (e.g., a portion of the road immediately ahead of the portion of the road the driver is currently traveling on). This analysis can account for the presence of turns or curves on a road or path (as determined based on inputs originating from sensors embedded within the vehicle, map/navigation data, and/or other information) which may impact or limit various view conditions such as the ability of the driver to perceive cars arriving from the opposite direction or cars driving in the same direction (whether in different lanes of the road or in the same lane), narrow segments of the road, poor road conditions, or sections of the road in which accidents occurred in the past.

By way of further illustration, in certain implementations the described technologies can be configured to analyze environmental/road conditions to determine suggested/required attention level(s), threshold(s), etc. (e.g., via a neural network and/or utilizing one or more machine learning techniques), in order for a driver to navigate a vehicle safely. Environmental or road conditions can include, but are not limited to: a road path (e.g., curves, etc.), environment (e.g., the presence of mountains, buildings, etc. that obstruct the sight of the driver), and/or changes in light conditions (e.g., sunlight or vehicle light directed towards the eyes of the driver, sudden darkness when entering a tunnel, etc.). Analyzing environmental or road conditions can be accounted for in determining a minimum time interval and/or likelihood time that it may take for a driver to be able to perceive a vehicle traveling on the same side or another side of the road, e.g., in a scenario in which such a vehicle is present on a portion of the road to which the driver is approaching but may not be presently visible to the driver due to an obstruction or sharp turn. By way of further example, the condition(s) can be accounted for in determining the required attention and/or time (e.g., a minimum time) that a driver/vehicle may need to maneuver (e.g., slow down, stop, move to the side, etc.) in a scenario in which the vehicle traveling on the other side of the road is not driving in its lane, or a vehicle driving in the same direction and in the same lane but at a much slower speed.

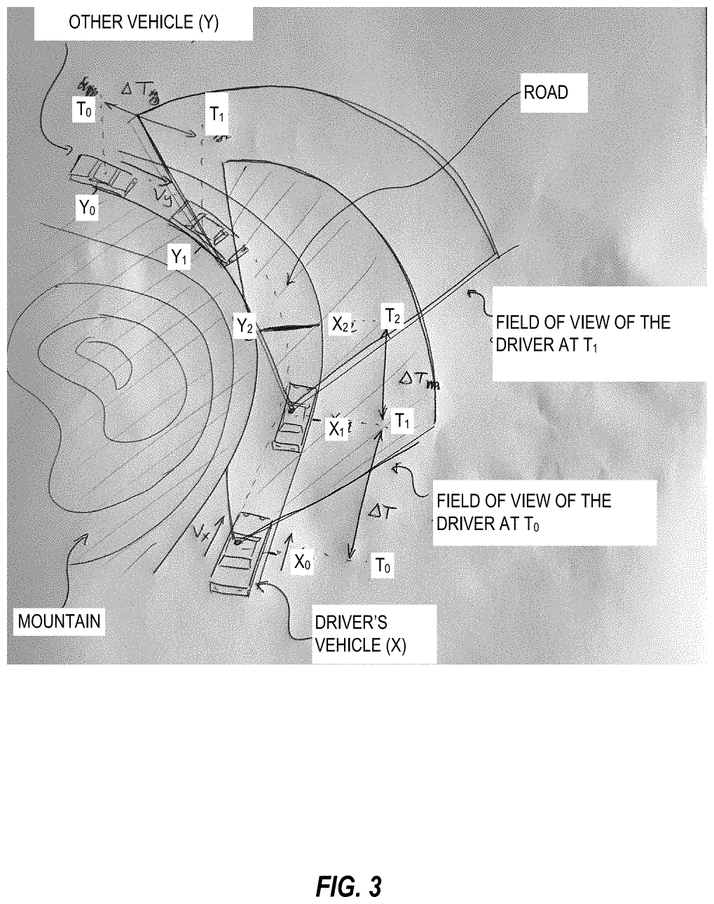

FIG. 3 depicts an example scenario in which the described system is implemented. As shown in FIG. 3, a driver (‘X’) drives in one direction while another vehicle (‘Y’) drives in the opposite direction. The presence of the mountain (as shown) creates a scenario in which the driver of vehicle ‘X’ may not see vehicle ‘Y’ as it approaches/passes the mountain. As shown in FIG. 3, at segment AT, the driver might first see vehicle Y in the opposite lane at location Y₁, as shown. At the point/segment at which X₂=Y₂ (as shown), which is the ‘meeting point,’ the driver will have ΔT_{M} to maneuver the vehicle in the event that vehicle Y enters the driver's lane. Accordingly, the described system can modify or adjust the attentiveness threshold of the driver in relation to ΔTM, e.g., as ΔT_{M} is lower, the required attentiveness of the driver at X₁ becomes higher. Accordingly, as described herein, the required attentiveness threshold can be modified in relation to environmental conditions. As shown in FIG. 3, the sight of the driver of vehicle ‘X’ can be limited by a mountain and the required attentiveness of the driver can be increased when reaching location X₁ (where at this location the driver must be highly attentive and look on the road). To do so, the system determines the driver attentiveness level before (X₀), and in case it doesn't cross the threshold required in coming location X₁, the system takes action (e.g., makes an intervention) in order to make sure the driver attentiveness will be above the required attentiveness threshold when reaching location X₁.

Additionally, in certain implementations the environmental conditions can be determined using information originating from other sensors, including but not limited to rain sensors, light sensors (e.g., corresponding to sunlight shining towards the driver), vibration sensors (e.g., reflecting road conditions or ice), camera sensors, ADAS, etc.

In certain implementations, the described technologies can also determine and/or otherwise account for information indicating or reflecting driving skills of the driver, the current driving state (as extracted, for example, from an ADAS, reflecting that the vehicle is veering towards the middle or sides of the road), and/or vehicle state (including speed, acceleration/deceleration, orientation on the road (e.g. during a turn, while overtaking/passing another vehicle).

In addition to and/or instead of utilizing information originating from sensor(s) within the vehicle, in certain implementations the described technologies can utilize information pertaining to the described environmental conditions extracted from external sources including: from the internet or ‘cloud’ services (e.g., external/cloud service 180, which can be accessed via a network such as the internet 160, as shown in FIG. 1), information stored at a local device (e.g., device 122, such as a smartphone, as shown in FIG. 1), or information stored at external devices (e.g., device 170 as shown in FIG. 1). For example, information reflecting weather conditions, sections of a road on which accidents have occurred, sharp turns, etc., can be obtained and/or received from various external data sources (e.g., third party services providing weather or navigation information, etc.).

Additionally, in certain implementations the described technologies can utilize or account for various phenomena exhibited by the driver in determining the driver awareness (e.g., via a neural network and/or utilizing one or more machine learning techniques). For example, in certain implementations various physiological phenomena can be accounted for such as the motion of the head of the driver, the gaze of the eyes of the driver, feature(s) exhibited by the eyes or eyelids of the driver, the direction of the gaze of the driver (e.g., whether the driver is looking towards the road), whether the driver is bored or daydreaming, the posture of the driver, etc. Additionally, in certain implementations, other phenomena can be accounted for such as the emotional state of the driver, whether the driver is too relaxed (e.g., in relation to upcoming conditions such as an upcoming sharp turn or ice on the next section of the road), etc.

Additionally, in certain implementations the described technologies can utilize or account for various behaviors or occurrences such as behaviors of the driver. By way of illustration, events taking place in the vehicle, the attention of a driver towards a passenger, passengers (e.g., children) asking for attention, events recently occurring in relation to device(s) of the driver/user (e.g., received SMS, voice, video message, etc. notifications) can indicate a possible change of attention of the driver (e.g., towards the device).

Accordingly, as described herein, the disclosed technologies can be configured to determine a required/suggested attention/attentiveness level (e.g., via a neural network and/or utilizing one or more machine learning techniques), and an alert to be provided to the driver, and/or action(s) to be initiated (e.g., an autonomous driving system takes control of the vehicle). In certain implementations, such determinations or operations can be computed or initiated based on/in view of aspects such as: state(s) associated with the driver (e.g., driver attentiveness state, physiological state, emotional state, etc.), the identity or history of the driver (e.g., using online learning or other techniques), state(s) associated with the road, temporal driving conditions (e.g., weather, vehicle density on the road, etc.), other vehicles, humans, objects etc. on the road or in the vicinity of the road (whether or not in motion, parked, etc.), history/statistics related to a section of the road (e.g., statistics corresponding to accidents that previously occurred at certain portions of a road, together with related information such as road conditions, weather information, etc. associated with such incidents), etc.

In one example implementation the described technologies can adjust (e.g., increase) a required driver attentiveness threshold in circumstances or scenarios in which a driver is traveling on a road on which traffic density is high and/or weather conditions are poor (e.g., rain or fog). In another example scenario, the described technologies can adjust (e.g., decrease) a required driver attentiveness threshold under circumstances in which traffic on a road is low, sections of the road are high quality, sections of the road are straight, there is a fence and/or distance between the two sides of the road, and/or visibility conditions on the road are clear.

Additionally, in certain implementations the determination of a required attentiveness threshold can further account for or otherwise be computed in relation to emotional state of the driver. For example, in a scenario in which the driver is determined to be more emotional disturbed, parameter(s) indicating the driver attentiveness to the road (such as driver gaze direction, driver behavior or actions) can be adjusted, e.g., to require a crossing higher threshold (or vice versa). In certain implementations, one or more of the determinations of an attentiveness threshold or an emotional state of the driver can be performed via a neural network and/or utilizing one or more machine learning techniques.

Additionally, in certain implementations the temporal road condition(s) can be obtained or received from external sources (e.g., ‘the cloud’). Examples of such temporal road condition(s) include but are not limited to changes in road condition due to weather event(s), ice on the road ahead, an accident or other incident (e.g., on the road ahead), vehicle(s) stopped ahead, vehicle(s) stopped on the side of the road, construction, etc.

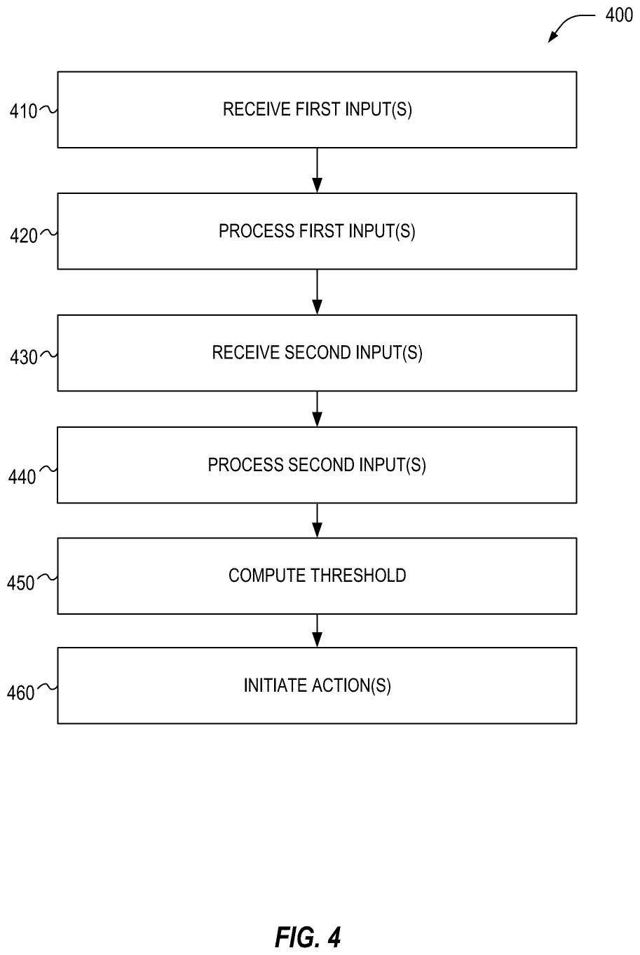

FIG. 4 is a flow chart illustrating a method 400, according to an example embodiment, for driver assistance. The method is performed by processing logic that can comprise hardware (circuitry, dedicated logic, etc.), software (such as is run on a computing device such as those described herein), or a combination of both. In one implementation, the method 400 (and the other methods described herein) is/are performed by one or more elements depicted and/or described in relation to FIG. 1 (including but not limited to device sensor 130 and/or integrated/connected computing devices, as described herein). In some other implementations, the one or more blocks of FIG. 4 can be performed by another machine or machines. Additionally, in certain implementations, one or more of the described operations can be performed via a neural network and/or utilizing one or more machine learning techniques.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 410, one or more first input(s) are received. In certain implementations, such inputs can be received from sensor(s) 130 and/or from other sources.

At operation 420, the one or more first inputs (e.g., those received at 410) are processed. In doing so, a state of a user (e.g., a driver present within a vehicle) can be determined. In certain implementations, the determination of the state of the driver/user can be performed via a neural network and/or utilizing one or more machine learning techniques.

In certain implementations, the ‘state of the driver/user’ can reflect, correspond to, and/or otherwise account for various identifications, determinations, etc. For example, in certain implementations determining the state of the driver can include identifying or determining (e.g., via a neural network and/or utilizing one or more machine learning techniques) motion(s) of the head of the driver, feature(s) of the eye(s) of the driver, a psychological state of the driver, an emotional state of the driver, a psychological state of the driver, a physiological state of the driver, a physical state of the driver, etc.

The state of the driver/user may relate to one or more behaviors of a driver, one or more psychological or emotional state(s) of the driver, one or more physiological or physical state(s) of the driver, or one or more activities the driver is or was engage with.

Furthermore, the driver state may relate to the context in which the driver is present. The context in which the driver is present may include the presence of other humans/passengers, one or more activities or behavior(s) of one or more passengers, one or more psychological or emotional state(s) of one or more passengers, one or more physiological or physical state(s) of one or more passengers, communication(s) with one or more passengers or communication(s) between one or more passengers, presence of animal(s) in the vehicle, one or more objects in the vehicle (wherein one or more objects present in the vehicle are defined as sensitive objects such as breakable objects like displays, objects from delicate material such as glass, art-related objects), the phase of the driving mode (manual driving, autonomous mode of driving), the phase of driving, parking, getting in/out of parking, driving, stopping (with brakes), the number of passengers in the vehicle, a motion/driving pattern of one or more vehicle(s) on the road, the environmental conditions. Furthermore, the driver state may relate to the appearance of the driver including, haircut, a change in haircut, dress, wearing accessories (such as glasses/sunglasses, earrings, piercing, hat), makeup.

Furthermore, the driver state may relate to facial features and expressions, out-of-position (e.g. legs up, lying down, etc.), person sitting on another person's lap, physical or mental distress, interaction with another person, emotional responses to content or event(s) taking place in the vehicle or outside the vehicle,

Furthermore, the driver state may relate to age, gender, physical dimensions, health, head pose, gaze, gestures, facial features and expressions, height, weight, pregnancy state, posture, seat validity (availability of seatbelt), interaction with the environment.

Psychological or emotional state of the driver may be any psychological or emotional state of the driver including but not limited to emotions of joy, fear, happiness, anger, frustration, hopeless, being amused, bored, depressed, stressed, or self-pity, being disturbed, in a state of hunger, or pain. Psychological or emotional state may be associated with events in which the driver was engaged with prior to or events in which the driver is engaged in during the current driving session, including but not limited to: activities (such as social activities, sports activities, work-related activities, entertainment-related activities, physical-related activities such as sexual, body treatment, or medical activities), communications relating to the driver (whether passive or active) occurring prior to or during the current driving session. By way of further example, the communications (which are accounted for in determining a degree of stress associated with the driver) can include communications that reflect dramatic, traumatic, or disappointing occurrences (e.g., the driver was fired from his/her job, learned of the death of a close friend/relative, learning of disappointing news associated with a family member or a friend, learning of disappointing financial news, etc.). Events in which the driver was engaged with prior to or events in which the driver during the current driving session may further include emotional response(s) to emotions of other humans in the vehicle or outside the vehicle, content being presented to the driver whether it is during a communication with one or more persons or broadcasted in its nature (such as radio). Psychological state may be associated with one or more emotional responses to events related to driving including other drivers on the road, or weather conditions. Psychological or emotional state may further be associated with indulging in self-observation, being overly sensitive to a personal/self-emotional state (e.g. being disappointed, depressed) and personal/self-physical state (being hungry, in pain).

Psychological or emotional state information may be extracted from an image sensor and/or external source(s) including those capable of measuring or determining various psychological, emotional or physiological occurrences, phenomena, etc. (e.g., the heart rate of the driver, blood pressure), and/or external online service, application or system (including data from ‘the cloud’).

Physiological or physical state of the driver may include: the quality and/or quantity (e.g., number of hours) of sleep the driver engaged in during a defined chronological interval (e.g., the last night, last 24 hours, etc.), body posture, skeleton posture, emotional state, driver alertness, fatigue or attentiveness to the road, a level of eye redness associated with the driver, a heart rate associated with the driver, a temperature associated with the driver, one or more sounds produced by the driver. Physiological or physical state of the driver may further include: information associated with: a level of driver's hunger, the time since the driver's last meal, the size of the meal (amount of food that was eaten), the nature of the meal (a light meal, a heavy meal, a meal that contains meat/fat/sugar), whether the driver is suffering from pain or physical stress, driver is crying, a physical activity the driver was engaged with prior to driving (such as gym, running, swimming, playing a sports game with other people (such a soccer or basketball), the nature of the activity (the intensity level of the activity (such as a light activity, medium or highly intensity activity), malfunction of an implant, stress of muscles around the eye(s), head motion, head pose, gaze direction patterns, body posture.

Physiological or physical state information may be extracted from an image sensor and/or external source(s) including those capable of measuring or determining various physiological occurrences, phenomena, etc. (e.g., the heart rate of the driver, blood pressure), and/or external online service, application or system (including data from ‘the cloud’).

In other implementations the ‘state of the driver/user’ can reflect, correspond to, and/or otherwise account for various identifications, determinations, etc. with respect to event(s) occurring within the vehicle, an attention of the driver in relation to a passenger within the vehicle, occurrence(s) initiated by passenger(s) within the vehicle, event(s) occurring with respect to a device present within the vehicle, notification(s) received at a device present within the vehicle, event(s) that reflect a change of attention of the driver toward a device present within the vehicle, etc. In certain implementations, these identifications, determinations, etc. can be performed via a neural network and/or utilizing one or more machine learning techniques.

The ‘state of the driver/user’ can also reflect, correspond to, and/or otherwise account for events or occurrences such as: a communications between a passenger and the driver, communication between one or more passengers, a passenger unbuckling a seat-belt, a passenger interacting with a device associated with the vehicle, behavior of one or more passengers within the vehicle, non-verbal interaction initiated by a passenger, or physical interaction(s) directed towards the driver.

Additionally, in certain implementations the ‘state of the driver/user’ can reflect, correspond to, and/or otherwise account for the state of a driver prior to and/or after entry into the vehicle. For example, previously determined state(s) associated with the driver of the vehicle can be identified, and such previously determined state(s) can be utilized in determining (e.g., via a neural network and/or utilizing one or more machine learning techniques) the current state of the driver. Such previously determined state(s) can include, for example, previously determined states associated during a current driving interval (e.g., during the current trip the driver is engaged in) and/or other intervals (e.g., whether the driver got a good night's sleep or was otherwise sufficiently rested before initiating the current drive). Additionally, in certain implementations a state of alertness or tiredness determined or detected in relation to a previous time during a current driving session can also be accounted for.

The ‘state of the driver/user’ can also reflect, correspond to, and/or otherwise account for various environmental conditions present inside and/or outside the vehicle.

At operation 430, one or more second input(s) are received. In certain implementations, such second inputs can be received from sensor(s) embedded within or otherwise configured with respect to a vehicle (e.g., sensors 140, as described herein). For example, such input(s) can originate from an ADAS or subset of sensors that make up an advanced driver-assistance system (ADAS).

At operation 440, the one or more second inputs (e.g., those received at 430) can be processed. In doing so, one or more navigation condition(s) associated with the vehicle can be determined or otherwise identified. In certain implementations, such processing can be performed via a neural network and/or utilizing one or more machine learning techniques. Additionally, the navigation condition(s) can originate from an external source (e.g., another device, ‘cloud’ service, etc.).

In certain implementations, ‘navigation condition(s)’ can reflect, correspond to, and/or otherwise account for road condition(s) (e.g., temporal road conditions) associated with the area or region within which the vehicle is traveling, environmental conditions proximate to the vehicle, presence of other vehicle(s) proximate to the vehicle, a temporal road condition received from an external source, a change in road condition due to weather event, a presence of ice on the road ahead of the vehicle, an accident on the road ahead of the vehicle, vehicle(s) stopped ahead of the vehicle, a vehicle stopped on the side of the road, a presence of construction on the road, a road path on which the vehicle is traveling, a presence of curve(s) on a road on which the vehicle is traveling, a presence of a mountain in relation to a road on which the vehicle is traveling, a presence of a building in relation to a road on which the vehicle is traveling, or a change in lighting conditions.

In other implementations, navigation condition(s) can reflect, correspond to, and/or otherwise account for various behavior(s) of the driver.

Behavior of a driver may relate to one or more actions, one or more body gestures, one or more posture, one or more activities. Driver behavior may relate to one or more events that take place in the car, attention toward one or more passenger(s), one or more kids in the back asking for attention. Furthermore, the behavior of a driver may relate to aggressive behavior, vandalism, or vomiting.

An activity can be an activity the driver is engaged in during the current driving interval or prior to the driving interval or an activity the driver was engaged in and which may include the amount of time the driver is driving during the current driving session and/or over a defined chronological interval (e.g., the past 24 hours), a frequency at which the driver engages in driving for an amount of time comparable to the duration of the driving session the driver is current engaged in.

Body posture can relate to any body posture of the driver during driving, including body postures which are defined by law as unsuitable for driving (such as placing legs on the dashboard), or body posture(s) that increase the risk for an accident to take place.

Body gestures relate to any gesture performed by the driver by one or more body part, including gestures performed by hands, head, or eyes.

A behavior of a driver can be a combination one or more actions, one or more body gestures, one or more postures, or one or more activities. For example, operating a phone while smoking, talking to passengers in the back while looking for an item in a bag, or talking to the driver while turning on the light in the vehicle while searching for an item that fell on the floor of the vehicle.

Actions include eating or drinking, touching parts of the face, scratching parts of the face, adjusting a position of glasses worn by the user, yawning, fixing the user's hair, stretching, the user searching their bag or another container, adjusting the position or orientation of the mirror located in the car, moving one or more handheld objects associated with the user, operating a handheld device such as a smartphone or tablet computer, adjusting a seat belt, buckling or unbuckling a seat-belt, modifying in-car parameters such as temperature, air-conditioning, speaker volume, windshield wiper settings, adjusting the car seat position or heating/cooling function, activating a window defrost device to clear fog from windows, a driver or front seat passenger reaching behind the front row towards objects in the rear seats, manipulating one or more levers for activating turn signals, talking, shouting, singing, driving, sleeping, resting, smoking, eating, drinking, reading, texting, moving one or more hand-held objects associated with the user, operating a hand-held device such as a smartphone or tablet computer, holding a mobile device, holding a mobile device against the cheek or holding it by hand for texting or in speakerphone mode, watching content, watching a video/film, the nature of the video/film being watched, listening to music/radio, operating a device, operating a digital device, operating an in-vehicle multimedia device, operating a device or digital conrol of the vehicle (such as opening a window or air-condition), modifying in-car parameters such as temperature, air-conditioning, speaker volume, windshield wiper settings, adjusting the car seat position or heating/cooling function, activating a window defrost device to clear fog from windows, manually moving arms and hands to wipe/remove fog or other obstructions from windows, a driver or passenger raising and placing legs on the dashboard, a driver or passenger looking down, a driver or other passengers changing seats, placing a baby in a baby-seat, taking a baby out of a baby-seat, placing a child into a child-seat, taking a child out of a child-seat, connecting a mobile device to the vehicle or to the multimedia system of the vehicle, placing a mobile device (e.g. mobile phone) in a cradle in the vehicle, operating an application on the mobile device or in the vehicle multimedia system, operating an application via voice commands and/or by touching the digital device and/or by using I/O module in the vehicle (such as buttons), operating an application/device that outputs its display in a head mounted display in front of the driver, operating streaming application (such as Spotify or YouTube), operating a navigation application or service, operating an application that outputs visual output (such as location on a map), making a phone call/video call, attending a meeting/conference call, talking/responding to being addressed during a conference call, searching for a device in the vehicle, searching for a mobile phone/communication device in the vehicle, searching for an object on the vehicle floor, searching an object within a bag, grabbing an object/bag from the backseat, operating an object with both hands, operating an object placed in the driver's lap, being involved in activities associated with eating such as taking food out from a bag/take-out box, interacting with one or more objects associated with food such as opening the cover of a sandwich/hamburger or placing sauce (ketchup) on the food, operating one or more objects associated with food with one hand, two hands or combination of one or two hands with other body part (such as teeth), looking at the food being eaten or at object associated with it (such as sauce, napkins etc.), being involved in activities associated with drinking, opening a can, placing a can between the legs to open it, interacting with the object associated with drinking with one or two hands, drinking a hot drink, drinking in a manner that the activity interferes with sight towards the road, being choked by food/drink, drinking alcohol, smoking substance that impairs or influences driving capabilities, assisting a passenger in the backseat, performing a gesture toward a device/digital device or an object, reaching towards or into the glove compartment, opening the door/roof, throwing an object out the window, talking to someone outside the car, looking at advertisement(s), looking at a traffic light/sign, looking at a person/animal outside the car, looking at an object/building/street sign, searching for a street sign (location)/parking place, looking at the I/O buttons on the steering wheel (controlling music/driving modes etc.), controlling the location/position of the seat, operating/fixing one or more mirrors of the vehicle, providing an object to other passengers/passenger on the back seat, looking at the mirror to communicate with passengers in the backseat, turning around to communicate with passengers in the backseat, stretching body parts, stretching body parts to release pain (such as neck pain), taking pills, interacting/playing with a pet/animal in the vehicle, throwing up, ‘dancing’ in the seat, playing a digital game, operating one or more digital display/smart windows, changing the lights in the vehicle, controlling the volume of the speakers, using a head mount device such as smart glasses, VR, AR, device learning, interacting with devices within a vehicle, fixing the safety belt, wearing a seat belt, wearing seatbelt incorrectly, seat belt fitting, opening a window, placing a hand or other body part outside the window, getting in or out of the vehicle, picking an object, looking for an object, interacting with other passengers, fixing/cleaning glasses, fixing/putting in contact lenses, fixing hair/dress, putting on lipstick, dressing or undressing, being involved in sexual activities, being involved in violence activity, looking at a mirror, communicating or interacting with one or more passenger sin the vehicle, communicating with one or more human/systems/AIs using a digital device, features associated with user behavior, interaction with the environment, activity, emotional responses (such as an emotional response to content or events), activity in relation to one or more objects, operating any interface device in the vehicle that may be controlled or used by the driver or passenger.

Actions may include actions or activities performed by the driver/passenger in relation to its body, including: facial related actions/activities such as yawning, blinking, pupil dilation, being surprised; performing a gesture toward the face with other body parts (such as hand, fingers), performing a gesture toward the face with an object held by the driver (a cap, food, phone), a gesture that is performed by other human/passenger toward the driver/user (e.g. gesture that is performed by a hand which is not the hand of the driver/user), fixing the position of glasses, put on/off glasses or fixing their position on the face, occlusion of a hand with features of the face (features that may be critical for detection of driver attentiveness, such as driver's eyes); or a gesture of one hand in relation to the other hand, to predict activities involving two hands which are not related to driving (e.g. opening a drinking can or a bottle, handling food). In another implementation, other objects proximate the user may include controlling a multimedia system, a gesture toward a mobile device that is placed next to the user, a gesture toward an application running on a digital device, a gesture toward the mirror in the car, or fixing the side mirrors.

Actions may also include any combination thereof.

The navigation condition(s) can also reflect, correspond to, and/or otherwise account for incident(s) that previously occurred in relation to a current location of the vehicle in relation to one or more incidents that previously occurred in relation to a projected subsequent location of the vehicle.

At operation 450, a threshold, such as a driver attentiveness threshold, can be computed and/or adjusted. In certain implementations, such a threshold can be computed based on/in view of one or more navigation condition(s) (e.g., those determined at 440). In certain implementations, such computation(s) can be performed via a neural network and/or utilizing one or more machine learning techniques. Such a driver attentiveness threshold can reflect, correspond to, and/or otherwise account for a determined attentiveness level associated with the driver (e.g., the user currently driving the vehicle) and/or with one or more other drivers of other vehicles in a proximity to the driver's vehicle or other vehicles projected to be in proximity to the driver's vehicle. In certain implementations, defining the proximity or projected proximity can be based on, but not limited to, being below a certain distance between the vehicle and the driver's vehicle or being below a certain distance between the vehicle and the driver's vehicle with in a defined time window.

The referenced driver attentiveness threshold can be further determined/computed based on/in view of one or more factors (e.g., via a neural network and/or utilizing one or more machine learning techniques). For example, in certain implementations the referenced driver attentiveness threshold can be computed based on/in view of: a projected/estimated time until the driver can see another vehicle present on the same side of the road as the vehicle, a projected/estimated time until the driver can see another vehicle present on the opposite side of the road as the vehicle, a projected/estimated time until the driver can adjust the speed of the vehicle to account for the presence of another vehicle, etc.

At operation 460, one or more action(s) can be initiated. In certain implementations, such actions can be initiated based on/in view of the state of the driver (e.g., as determined at 420) and/or the driver attentiveness threshold (e.g., as computed at 450). Actions can include changing parameters related to the vehicle or to the driving, such as: controlling a car's lights (e.g., turn on/off the bright headlights of the vehicle, turn on/off the warning lights or turn signal(s) of the vehicle, reduce/increase the speed of the vehicle).

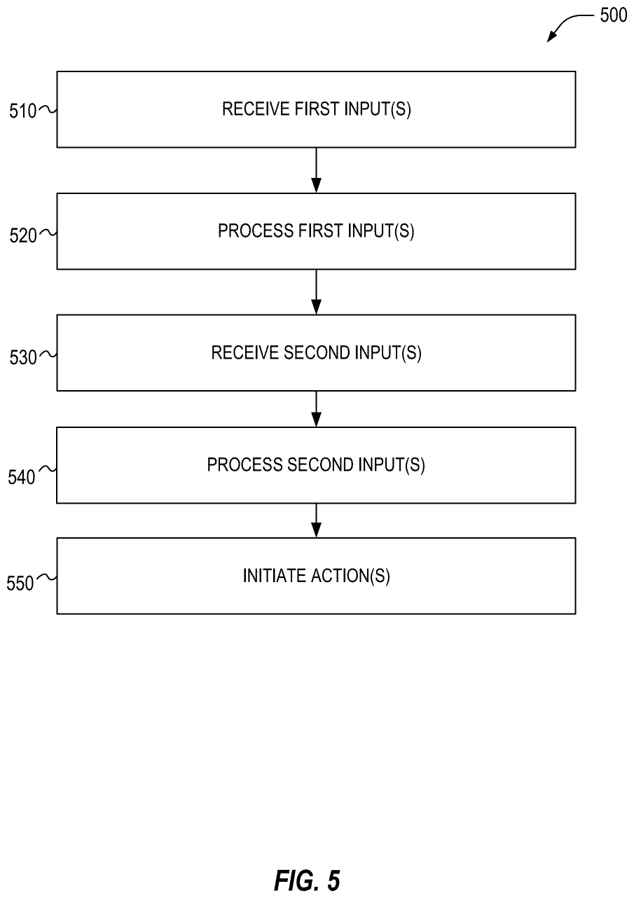

FIG. 5 is a flow chart illustrating a method 500, according to an example embodiment, for driver assistance. The method is performed by processing logic that can comprise hardware (circuitry, dedicated logic, etc.), software (such as is run on a computing device such as those described herein), or a combination of both. In one implementation, the method 500 (and the other methods described herein) is/are performed by one or more elements depicted and/or described in relation to FIG. 1 (including but not limited to device sensor 130 and/or integrated/connected computing devices, as described herein). In some other implementations, the one or more blocks of FIG. 5 can be performed by another machine or machines. Additionally, in certain implementations, one or more of the described operations can be performed via a neural network and/or utilizing one or more machine learning techniques.

At operation 510, one or more first input(s) are received. In certain implementations, such inputs can be received from sensor(s) embedded within or otherwise configured with respect to a vehicle (e.g., sensors 140, as described herein). For example, such input(s) can originate from an ADAS or one or more sensors that make up an advanced driver-assistance system (ADAS). For example, FIG. 1 depicts sensors 140 that are integrated or included as part of ADAS 150.

At operation 520, the one or more first input(s) (e.g., those received at 510) are processed (e.g., via a neural network and/or utilizing one or more machine learning techniques). In doing so, a first object can be identified. In certain implementations, such an object can be identified in relation to a vehicle (e.g., the vehicle within which a user/driver is traveling). Examples of the object include but are not limited to road signs, road structures, etc.

At operation 530, one or more second input(s) are received.

At operation 540, the one or more second input(s) (e.g., those received at 530) are processed. In doing so, a state of attentiveness of a user/driver of the vehicle can be determined. In certain implementations, such a state of attentiveness can be determined with respect to an object (e.g., the object identified at 520). Additionally, in certain implementations, the state of attentiveness can be determined based on/in view of previously determined state(s) of attentiveness associated with the driver of the vehicle, e.g., in relation to object(s) associated with the first object. In certain implementations, the determination of a state of attentiveness of a user/driver can be performed via a neural network and/or utilizing one or more machine learning techniques.

In certain implementations, the previously determined state(s) of attentiveness can be those determined with respect to prior instance(s) within a current driving interval (e.g., during the same trip, drive, etc.) and/or prior driving interval(s) (e.g., during previous trips/drives/flights). In certain implementations, the previously determined state(s) of attentiveness can be determined via a neural network and/or utilizing one or more machine learning techniques.

Additionally, in certain implementations the previously determined state(s) of attentiveness can reflect, correspond to, and/or otherwise account for a dynamic or other such patterns, trends, or tendencies reflected by previously determined state(s) of attentiveness associated with the driver of the vehicle in relation to object(s) associated with the first object (e.g., the object identified at 520). Such a dynamic can reflect previously determined state(s) of attentiveness including, for example: a frequency at which the driver looks at the first object (e.g., the object identified at 520), a frequency at which the driver looks at a second object (e.g., another object), one or more circumstances under which the driver looks at one or more objects, one or more circumstances under which the driver does not look at one or more objects, one or more environmental conditions, etc.

By way of further illustration, the dynamic can reflect, correspond to, and/or otherwise account for a frequency at which the driver looks at certain object(s) (e.g., road signs, traffic lights, moving vehicles, stopped vehicles, stopped vehicles on the side of the road, vehicles approaching an intersection or square, humans or animals walking/standing on the sidewalk or on the road or crossing the road, a human working or standing on the road and/or signing (e.g. police officer or traffic related worker), a vehicle stopping, red lights of vehicle in the field of view of the driver, objects next to or on the road, landmarks, buildings, advertisements, any object(s) that signal to the driver (such as indicating a lane is closed, cones located on the road, blinking lights etc.), etc.), what object(s) the driver looks at, sign(s), etc. the driver is looking at, circumstance(s) under which the driver looks at certain objects (e.g., when driving on a known path, the driver doesn't look at certain road signs (such as stop signs or speed limits signs) due to his familiarity with the signs' information, road and surroundings, while driving on unfamiliar roads the driver looks with an 80% rate/frequency at speed limit signs, and with a 92% rate/frequency at stop signs), driving patterns of the driver (e.g., the rate/frequency at which the driver looks at signs in relation to the speed of the car, road conditions, weather conditions, times of the day, etc.), etc.

Additionally, in certain implementations the dynamic can reflect, correspond to, and/or otherwise account for physiological state(s) of the driver and/or other related information. For example, previous driving or behavior patterns exhibited by the driver (e.g., at different times of the day) and/or other patterns pertaining to the attentiveness of the driver (e.g., in relation to various objects) can be accounted for in determining the current attentiveness of the driver and/or computing various other determinations described herein. In certain implementations, the current attentiveness of the driver can be determined via a neural network and/or utilizing one or more machine learning techniques.

Moreover, in certain implementations the previously determined state(s) of attentiveness can reflect, correspond to, and/or otherwise account for a statistical model of a dynamic reflected by one or more previously determined states of attentiveness associated with the driver of the vehicle, e.g., in relation to object(s) associated with the first object (e.g., the object identified at 520).

In certain implementations, determining a current state of attentiveness can further include correlating previously determined state(s) of attentiveness associated with the driver of the vehicle and the first object with the one or more second inputs (e.g., those received at 530). In certain implementations, the current attentiveness of the driver can be determined via a neural network and/or utilizing one or more machine learning techniques.

Additionally, in certain implementations the described technologies can be configured to determine the attentiveness of the driver based on/in view of data reflecting or corresponding to the driving of the driver and aspects of the attentiveness exhibited by the driver to various to cues or objects (e.g., road signs) in previous driving session(s). For example, using data corresponding to instance(s) in which the driver is looking at certain object(s), a dynamic, pattern, etc. that reflects the driver's current attentiveness to such object(s) can be correlated with dynamic(s) computed with respect to previous driving session(s). It should be understood that the dynamic can include or reflect numerous aspects of the attentiveness of the driver, such as: a frequency at which the driver looks at certain object(s) (e.g., road signs), what object(s) (e.g., signs, landmarks, etc.) the driver is looking at, circumstances under which the driver is looking at such object(s) (for example, when driving on a known path the driver may frequently be inattentive to speed limit signs, road signs, etc., due to the familiarity of the driver with the road, while when driving on unfamiliar roads the driver may look at speed-limit signs at an 80% rate/frequency and look at stop signs with a 92% frequency), driving patterns of the driver (e.g., the rate/frequency at which the driver looks at signs in relation to the speed of the car, road conditions, weather conditions, times of the day, etc.), etc. In certain implementations, the attentiveness of the driver can be determined via a neural network and/or utilizing one or more machine learning techniques.

Additionally, in certain implementations the state of attentiveness of the driver can be further determined based on/in view of a frequency at which the driver looks at the first object (e.g., the object identified at 520), a frequency at which the driver looks at a second object, driving pattern(s), driving pattern(s) associated with the driver in relation to driving-related information including, but not limited to, navigation instruction(s), environmental conditions, or a time of day. In certain implementations, the state of attentiveness of the driver can be determined via a neural network and/or utilizing one or more machine learning techniques.

In certain implementations, the state of attentiveness of the driver can be further determined based on/in view at least one of: a degree of familiarity of the driver with respect to a road being traveled, the frequency of traveling the road being traveled, the elapsed time since the previous traveling the road being traveled. In certain implementations, the state of attentiveness of the driver can be determined via a neural network and/or utilizing one or more machine learning techniques.

Moreover, in certain implementations, the state of attentiveness of the driver can be further determined (e.g., via a neural network and/or utilizing one or more machine learning techniques) based on/in view of a psychological state of the driver, a physiological state of the driver, an amount of sleep the driver is determined to have engaged in, an amount of driving the driver is determined to have engaged in, a level of eye redness associated with the driver, etc. For example, the state of attentiveness of the driver (reflecting the degree to which the driver is attentive to the road and/or other surroundings) can be determined by correlating data associated with physiological characteristics of the driver (e.g., as received, obtained, or otherwise computed from information originating at a sensor) with other physiological information associated with the driver (e.g., as received or obtained from an application or external data source such as ‘the cloud’). As described herein, the physiological characteristics, information, etc. can include aspects of tiredness, stress, health/sickness, etc. associated with the driver.

Additionally, in certain implementations the physiological characteristics, information, etc. can be utilized to define and/or adjust driver attentiveness thresholds, such as those described above in relation to FIG. 4. For example, physiological data received or obtained from an image sensor and/or external source(s) (e.g., other sensors, another application, from ‘the cloud,’ etc.) can be used to define and/or adjust a threshold that reflects a required or sufficient degree of attentiveness (e.g., for the driver to navigate safely) and/or other levels or measures of tiredness, attentiveness, stress, health/sickness etc.

By way of further illustration, the described technologies can determine (e.g., via a neural network and/or utilizing one or more machine learning techniques) the state of attentiveness of the driver based on/in view of information or other determinations that reflect a degree or measure of tiredness associated with the driver. In certain implementations, such a degree of tiredness can be obtained or received from and/or otherwise determined (e.g., via a neural network and/or utilizing one or more machine learning techniques) based on information originating at other sources or systems. Such information or determinations can include, for example, a determined quality and/or quantity (e.g., number of hours) of sleep the driver engaged in during a defined chronological interval (e.g., the last night, last 24 hours, etc.), the amount of time the driver is driving during the current driving session and/or over a defined chronological interval (e.g., the past 24 hours), a frequency at which the driver engages in driving for an amount of time comparable to the duration of the driving session the driver is current engaged in, etc. Additionally, in certain implementations the described technologies can further correlate the determination(s) associated with the state of attentiveness of the driver with information extracted/originating from image sensor(s) (e.g., those capturing images of the driver) and/or other sensors capable of measuring or determining various physiological occurrences, phenomena, etc. (e.g., the heart rate of the driver) and/or external online service, application or system such as Driver Monitoring System (DMS) or Occupancy Monitoring System (OMS).

DMS is a system that tracks the driver and acts according to the driver's detected state, physical condition, emotional condition, actions, behaviors, driving performance, attentiveness, or alertness. A DMS can include modules that detect or predict gestures, motion, body posture, features associated with user alertness, driver alertness, fatigue, attentiveness to the road, distraction, features associated with expressions or emotions of a user, or features associated with gaze direction of a user, driver or passenger. Other modules detect or predict driver/passenger actions and/or behavior.

In another implementation, a DMS can detect facial attributes including head pose, gaze, face and facial attributes, three-dimensional location, facial expression, facial elements including: mouth, eyes, neck, nose, eyelids, iris, pupil, accessories including: glasses/sunglasses, earrings, makeup; facial actions including: talking, yawning, blinking, pupil dilation, being surprised; occluding the face with other body parts (such as hand or fingers), with other objects held by the user (a cap, food, phone), by another person (another person's hand) or object (a part of the vehicle), or expressions unique to a user (such as Tourette's Syndrome-related expressions).

OMS is a system which monitors the occupancy of a vehicle's cabin, detecting and tracking people and objects, and acts according to their presence, position, pose, identity, age, gender, physical dimensions, state, emotion, health, head pose, gaze, gestures, facial features and expressions. An OMS can include modules that detect one or more person and/or the identity, age, gender, ethnicity, height, weight, pregnancy state, posture, out-of-position (e.g. leg's up, lying down, etc.), seat validity (availability of seatbelt), skeleton posture, or seat belt fitting of a person; presence of an object, animal, or one or more objects in the vehicle; learning the vehicle interior; an anomaly; a child/baby seat in the vehicle, a number of persons in the vehicle, too many persons in a vehicle (e.g. 4 children in rear seat, while only 3 allowed), or a person sitting on other person's lap.

An OMS can include modules that detect or predict features associated with user behavior, action, interaction with the environment, interaction with another person, activity, emotional state, emotional responses to: content, event, trigger another person, one or more objects, detecting a presence of a child in the car after all adults left the car, monitoring back-seat of a vehicle, identifying aggressive behavior, vandalism, vomiting, physical or mental distress, detecting actions such as smoking, eating and drinking, or understanding the intention of the user through their gaze or other body features.

In certain implementations, the state of attentiveness of the driver can be further determined based on/in view of information associated with patterns of behavior exhibited by the driver with respect to looking at certain object(s) at various times of day. Additionally, in certain implementations the state of attentiveness of the driver can be further determined based on/in view of physiological data or determinations with respect to the driver, such as the tiredness, stress, sickness, etc., of the driver. In certain implementations, the state of attentiveness of the driver can be determined via a neural network and/or utilizing one or more machine learning techniques.

Additionally, in certain implementations, aspects reflecting or corresponding to a measure or degree of tiredness can be obtained or received from and/or otherwise determined (e.g., via a neural network and/or utilizing one or more machine learning techniques) based on information originating at other sources or systems. Such information or determinations can include, for example, a determined quality and/or quantity (e.g., number of hours) of sleep the driver engaged in during a defined chronological interval (e.g., the last night, last 24 hours, etc.), the amount of time the driver is driving during the current driving session and/or over a defined chronological interval (e.g., the past 24 hours), a frequency at which the driver engages in driving for an amount of time comparable to the duration of the driving session the driver is current engaged in, etc. Additionally, in certain implementations the described technologies can further correlate the determination(s) associated with the state of attentiveness of the driver with information extracted/originating from image sensor(s) (e.g., those capturing images of the driver) and/or other sensors (such as those that make up a driver monitoring system and/or an occupancy monitoring system) capable of measuring or determining various physiological occurrences, phenomena, etc. (e.g., the heart rate of the driver).

Additionally, in certain implementations, the described technologies can determine the state of attentiveness of the driver and/or the degree of tiredness of the driver based on/in view of information related to and/or obtained in relation to the driver, such an information pertaining to the eyes, eyelids, pupil, eyes redness level (e.g., as compared to a normal level), stress of muscles around the eye(s), head motion, head pose, gaze direction patterns, body posture, etc., of the driver can be accounted for in computing the described determination(s). Moreover, in certain implementations the determinations can be further correlated with prior determination(s) (e.g., correlating a current detected body posture of the driver with the detected body posture of the driver in previous driving session(s)). In certain implementations, the state of attentiveness of the driver and/or the degree of tiredness of the driver can be determined via a neural network and/or utilizing one or more machine learning techniques.

Aspects reflecting or corresponding to a measure or degree of stress can be obtained or received from and/or otherwise determined (e.g., via a neural network and/or utilizing one or more machine learning techniques) based on/in view of information originating from other sources or systems. Such information or determinations can include, for example, physiological information associated with the driver, information associated with behaviors exhibited by the driver, information associated with events engaged in by the driver prior to or during the current driving session, data associated with communications relating to the driver (whether passive or active) occurring prior to or during the current driving session, etc. By way of further example, the communications (which are accounted for in determining a degree of stress associated with the driver) can include communications that reflect dramatic, traumatic, or disappointing occurrences (e.g., the driver was fired from his/her job, learned of the death of a close friend/relative, learning of disappointing news associated with a family member or a friend, learning of disappointing financial news, etc.). The stress determinations can be computed or determined based on/in view of information originating from other sources or systems (e.g., from ‘the cloud,’ from devices, external services, and/or applications capable of determining a stress level of a user, etc.).

It can be appreciated that when a driver is experiencing stress or other emotions, various driving patterns or behaviors may change. For example, the driver may be less attentive to surrounding cues or objects (e.g., road signs) while still being attentive (or overly focused) on the road itself. This (and other) phenomena can be accounted for in determining (e.g., via a neural network and/or utilizing one or more machine learning techniques) an attentiveness level of a driver under various conditions.

Additionally, in certain implementations the described technologies can determine the state of attentiveness of the driver (e.g., via a neural network and/or utilizing one or more machine learning techniques) based on/in view of information or other determinations that reflect the health of a driver. For example, a degree or level of sickness of a driver (e.g., the severity of a cold the driver is currently suffering from) can be determined based on/in view of data extracted from image sensor(s) and/or other sensors that measure various physiological phenomenal (e.g., the temperature of the driver, sounds made by the driver such as coughing or sneezing, etc.). As noted, the health/sickness determinations can be computed or determined based on/in view of information originating from other sources or systems (e.g., from ‘the cloud,’ from devices, external services, and/or applications capable of determining a health level of a user, etc.). In certain implementations, the health/sickness of the driver can be determined via a neural network and/or utilizing one or more machine learning techniques.

The described technologies can also be configured to determine the state of attentiveness of the driver (e.g., via a neural network and/or utilizing one or more machine learning techniques) and/or perform other related computations/operations based on/in view of various other activities, behaviors, etc. exhibited by the driver. For example, aspects of the manner in which the driver looks at various objects (e.g., road signs, etc.) can be correlated with other activities or behaviors exhibited by the driver, such whether the driver is engaged in conversation, in a phone call, listening to radio/music, etc. Such determination(s) can be further correlated with information or parameters associated with other activities or occurrences, such as the behavior exhibited by other passengers in the vehicle (e.g., whether such passengers are speaking, yelling, crying, etc.) and/or other environmental conditions of the vehicle (e.g., the level of music/sound). Moreover, in certain implementations the determination(s) can be further correlated with information corresponding to other environmental conditions (e.g., outside the vehicle), such as weather conditions, light/illumination conditions (e.g., the presence of fog, rain, sunlight originating from the direction of the object which may inhibit the eyesight of the driver), etc. Additionally, in certain implementations the determination(s) can be further correlated with information or parameters corresponding to or reflecting various road conditions, speed of the vehicle, road driving situation(s), other car movements (e.g., if another vehicle stops suddenly or changes direction rapidly), time of day, light/illumination present above objects (e.g., how well the road signs or landmarks are illuminated), etc. By way of further illustration, various composite behavior(s) can be identified or computed, reflecting, for example, multiple aspects relating to the manner in which a driver looks at a sign in relation to one or more of the parameters. In certain implementations the described technologies can also determine and/or otherwise account for subset(s) of the composite behaviors (reflecting multiple aspects of the manner in which a driver behaves while looking at certain object(s) and/or in relation to various driving condition(s)). The information and/or related determinations can be further utilized in determining whether the driver is more or less attentive, e.g., as compared to his normal level of attentiveness, in relation to an attentiveness threshold (reflecting a minimum level of attentiveness considered to be safe), determining whether the driver is tired, etc., as described herein. For example, history or statistics obtained or determined in relation to prior driving instances associated with the driver can be used to determine a normal level of attentiveness associated with the driver. Such a normal level of attentiveness can reflect for example, various characteristics or ways in which the driver perceives various objects and/or otherwise acts while driving. By way of illustration, a normal level of attentiveness can reflect or include an amount of time and/or distance that it takes a driver to notice and/or respond to a road sign while driving (e.g., five seconds after the sign is visible; at a distance of 30 meters from the sign, etc.). Behaviors presently exhibited by the driving can be compared to such a normal level of attentiveness to determine whether the driver is currently driving in a manner in which he/she normally does, or whether the driver is currently less attentive. In certain implementations, the normal level of attentiveness of the driver may be average or median of the determined values reflected the level of attentiveness of the driver in previous driving internal. In certain implementations, the normal level of attentiveness of the driver may be determined using information from one or more sensors including information reflecting at least one of behavior of the driver, physiological or physical state of the driver, psychological or emotional state of the driver during the driving interval.

In certain implementations, the described technologies can be further configured to utilized and/or otherwise account for the gaze of the driver in determining the attentiveness of the driver. For example, object(s) can be identified (whether inside or outside the vehicle), as described herein, and the gaze direction of the eyes of the driver can be detected. Such objects can include, for example, objects detected using data from image sensor information, from camera(s) facing outside or inside the vehicle, objects detected by radar or LIDAR, objects detected by ADAS, etc. Additionally, various techniques and/or technologies (e.g., DMS or OMS) can be utilized to detect or determine the gaze direction of the driver and/or whether the driver looking towards/at a particular object. Upon determining that the driver is looking towards/at an identified object, the attentiveness of the driver can be computed (e.g., based on aspects of the manner in which the driver looks at such an object, such as the speed at which the driver is determined to recognize an object once the object is in view). Additionally, in certain implementations the determination can further utilize or account for data indicating the attentiveness of the driver with respect to associated/related objects (e.g., in previous driving sessions and/or earlier in the same driving session).

In certain implementations, the state of attentiveness or tiredness of the driver can be further determined based on/in view of information associated with a time duration during which the driver shifts his gaze towards the first object (e.g., the object identified at 520).

Additionally, in certain implementations, the state of attentiveness or tiredness of the driver can be further determined based on/in view of information associated with a shift of a gaze of the driver towards the first object (e.g., the object identified at 520).

In certain implementations, determining a current state of attentiveness or tiredness can further include processing previously determined chronological interval(s) (e.g., previous driving sessions) during which the driver of the vehicle shifts his gaze towards object(s) associated with the first object in relation to a chronological interval during which the driver shifts his gaze towards the first object (e.g., the object identified at 520). In doing so, a current state of attentiveness or tiredness of the driver can be determined.

Additionally, in certain implementations the eye gaze of a driver can be further determined based on/in view of a determined dominant eye of the driver (as determined based on various viewing rays, winking performed by the driver, and/or other techniques). The dominant eye can be determined using information extracted by other device, application, online service or a system, and stored on the device or on another device (such as server connected via a network to the device). Furthermore, such information may include information stored in the cloud.

Additionally, in certain implementations, determining a current state of attentiveness or tiredness of a driver can further include determining the state of attentiveness or tiredness based on information associated with a motion feature related to a shift of a gaze of the driver towards the first object.

At operation 550, one or more actions can be initiated, e.g., based on the state of attentiveness of a driver (such as is determined at 540). Such actions can include changing parameters related to the vehicle or to the driving, such as: controlling a car's lights (e.g., turn on/off the bright headlights of the vehicle, turn on/off the warning lights or turn signal(s) of the vehicle, reduce/increase the speed of the vehicle).

FIG. 4 is a flow chart illustrating a method 400, according to an example embodiment, for driver assistance. The method is performed by processing logic that can comprise hardware (circuitry, dedicated logic, etc.), software (such as is run on a computing device such as those described herein), or a combination of both. In one implementation, the method 400 (and the other methods described herein) is/are performed by one or more elements depicted and/or described in relation to FIG. 1 (including but not limited to device sensor 130 and/or integrated/connected computing devices, as described herein). In some other implementations, the one or more blocks of FIG. 4 can be performed by another machine or machines. Additionally, in certain implementations, one or more of the described operations can be performed via a neural network and/or utilizing one or more machine learning techniques.

At operation 610, one or more first input(s) are received. In certain implementations, such inputs can be received from sensor(s) embedded within or otherwise configured with respect to a vehicle (e.g., sensors 140, as described herein). For example, such input(s) can originate from external system including advanced driver-assistance system (ADAS) or sensors that make up an advanced driver-assistance system (ADAS).

At operation 620, the one or more first input(s) (e.g., those received at 610) are processed. In doing so, a first object is identified. In certain implementations, such an object is identified in relation to a vehicle (e.g., the vehicle within which a user/driver is traveling). Examples of the referenced object include but are not limited to road signs, road structures, etc.

At operation 630, one or more second inputs are received.

At operation 640, the one or more second input(s) (e.g., those received at 630) are processed. In doing so, a state of attentiveness of a driver of the vehicle is determined. In certain implementations, such a state of attentiveness can include or reflect a state of attentiveness of the user/driver with respect to the first object (e.g., the object identified at 620). Additionally, in certain implementations, the state of attentiveness can be computed based on/in view of a direction of the gaze of the driver in relation to the first object (e.g., the object identified at 620) and/or one or more condition(s) under which the first object is perceived by the driver. In certain implementations, the state of attentiveness of a driver can be determined via a neural network and/or utilizing one or more machine learning techniques.

In certain implementations, the conditions can include, for example, a location of the first object in relation to the driver, a distance of the first object from the driver, etc. in other implementations, the ‘conditions’ can include environmental conditions such as a visibility level associated with the first object, a driving attention level, a state of the vehicle, one or more behaviors of passenger(s) present within the vehicle, etc.

In certain implementations, the determined location of the first object in relation to the driver, and/or the distance of the first object from the driver, can be utilized by ADAS systems and/or different techniques that measure distance such as LIDAR and projected pattern. In certain implementations, the location of the first object in relation to the driver can be determined via a neural network and/or utilizing one or more machine learning techniques.

The ‘visibility level’ can be determined (e.g., via a neural network and/or utilizing one or more machine learning techniques), for example, using information associated with rain, fog, snow, dust, sunlight, lighting conditions associated with the first object, etc. In certain implementations, the ‘driving attention level’ can be determined (e.g., via a neural network and/or utilizing one or more machine learning techniques) using information associated with road related information, such as a load associated with the road on which the vehicle is traveling, conditions associated with the road on which the vehicle is traveling, lighting conditions associated with the road on which the vehicle is traveling, rain, fog, snow, wind, sunlight, twilight time, driving behavior of other cars, lane changes, bypassing a vehicle, changes in road structure occurring since a previous instance in which the driver drove on the same road, changes in road structure occurring since a previous instance in which the driver drove to the current destination of the driver, a manner in which the driver responds to one or more navigation instructions, etc. Further aspects of determining the driver attention level are described herein in relation to determining a state of attentiveness.

The ‘behavior of passenger(s) within the vehicle’ refers to any type of behavior of one or more passengers in the vehicle including or reflecting a communication of a passenger with the driver, communication between one or more passengers, a passenger unbuckling a seatbelt, a passenger interacting with a device associated with the vehicle, behavior of passengers in the back seat of the vehicle, non-verbal interactions between a passenger and the driver, physical interactions associated with the driver, and/or any other behavior described and/or referenced herein.

In certain implementations, the state of attentiveness of the driver can be further determined (e.g., via a neural network and/or utilizing one or more machine learning techniques) based on/in view of a psychological state of the driver, a physiological state of the driver, an amount of sleep the driver is determined to have engaged in, an amount of driving the driver is determined to have engaged it, a level of eye redness associated with the driver, a determined quality of sleep associated with the driver, a heart rate associated with the driver, a temperature associated with the driver, one or more sounds produced by the driver, etc.

At operation 650, one or more actions are initiated. In certain implementations, such actions can be initiated based on/in view of the state of attentiveness of a driver (e.g., as determined at 440). Such actions can include changing parameters related to the vehicle or to the driving, such as: controlling a car's lights (e.g., turn on/off the bright headlights of the vehicle, turn on/off the warning lights or turn signal(s) of the vehicle, reduce/increase the speed of the vehicle).

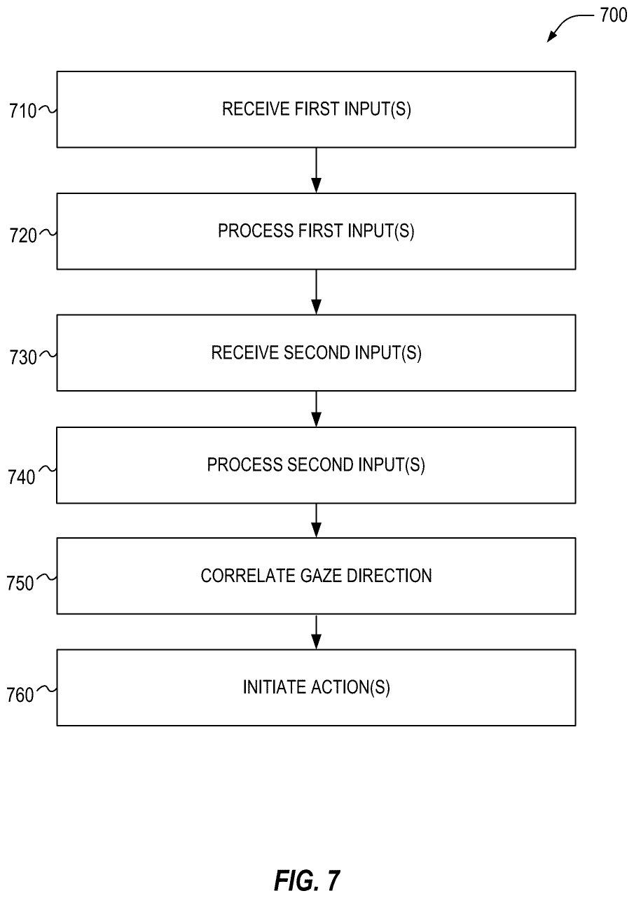

FIG. 7 is a flow chart illustrating a method 700, according to an example embodiment, for driver assistance. The method is performed by processing logic that can comprise hardware (circuitry, dedicated logic, etc.), software (such as is run on a computing device such as those described herein), or a combination of both. In one implementation, the method 700 (and the other methods described herein) is/are performed by one or more elements depicted and/or described in relation to FIG. 1 (including but not limited to device sensor 130 and/or integrated/connected computing devices, as described herein). In some other implementations, the one or more blocks of FIG. 7 can be performed by another machine or machines. Additionally, in certain implementations, one or more of the described operations can be performed via a neural network and/or utilizing one or more machine learning techniques.

At operation 710, one or more first inputs are received. In certain implementations, such inputs can be received from one or more first sensors. Such first sensors can include sensors that collect data within the vehicle (e.g., sensor(s) 130, as described herein).

At operation 720, the one or more first inputs can be processed. In doing so, a gaze direction is identified, e.g., with respect to a driver of a vehicle. In certain implementations, the gaze direction can be identified via a neural network and/or utilizing one or more machine learning techniques.

At operation 730, one or more second inputs are received. In certain implementations, such inputs can be received from one or more second sensors, such as sensors configured to collect data outside the vehicle (e.g., as part of an ADAS, such as sensors 140 that are part of ADAS 150 as shown in FIG. 1).

In certain implementations, the ADAS can be configured to accurately detect or determine (e.g., via a neural network and/or utilizing one or more machine learning techniques) the distance of objects, humans, etc. outside the vehicle. Such ADAS systems can utilize different techniques to measure distance including LIDAR and projected pattern. In certain implementations it can be advantageous to further validate such a distance measurement computed by the ADAS.

The ADAS systems can also be configured to identify, detect, and/or localize traffic signs, pedestrians, other obstacles, etc. Such data can be further aligned with data originating from a driver monitoring system (DMS). In doing so, a counting based measure can be implemented in order to associated aspects of determined driver awareness with details of the scene.

In certain implementations, the DMS system can provide continuous information about the gaze direction, head-pose, eye openness, etc. of the driver. Additionally, the computed level of attentiveness while driving can be correlated with the driver's attention to various visible details with information from the forward-looking ADAS system. Estimates can be based on frequency of attention to road-cues, time-between attention events, machine learning, or other means.

At operation 740 the one or more second inputs (e.g., those received at 730) are processed. In doing so, a location of one or more objects (e.g., road signs, landmarks, etc.) can be determined. In certain implementations, the location of such objects can be determined in relation to a field of view of at least one of the second sensors. In certain implementations, the location of one or more objects can be determined via a neural network and/or utilizing one or more machine learning techniques.

In certain implementations, a determination computed by an ADAS system can be validated performed in relation to one or more predefined objects (e.g., traffic signs). The predefined objects can be associated with criteria reflecting at least one of: a traffic signs object, an object having a physical size less than a predefined size, an object whose size as perceived by one or more sensors is less than a predefined size, or an object positioned in a predefined orientation in relation to the vehicle (e.g., objects that are facing the vehicle may be the same distance from the vehicle as compared to a distance measured to a car driving on the next lane, which can correspond to a distance from the front of the car from the vehicle and the back part of the car from the vehicle, and all the other points in between).

In certain implementations, the predefined orientation of the object in relation to the vehicle can relate to object(s) that are facing the vehicle. Additionally, in certain implementations the determination computed by an ADAS system can be in relation to predefined objects.

In certain implementations, a determination computed by an ADAS system can be validated in relation to a level of confidence of the system in relation to determined features associated with the driver. These features can include but are not limited to a location of the driver in relation to at least one of the sensors, a location of the eyes of the driver in relation to one or more sensors, or a line of sight vector as extracted from a driver gaze detection.

Additionally, in certain implementations, processing the one or more second inputs further comprises calculating a distance of an object from a sensor associated with an ADAS system, and using the calculated distance as a statistical validation to a distance measurement determined by the ADAS system.

At operation 750, the gaze direction of the driver (e.g., as identified at 720) can be correlated with the location of the one or more objects (e.g., as determined at 740). In certain implementations, the gaze direction of the driver can be correlated with the location of the object(s) in relation to the field of view of the second sensor(s). In doing so, it can be determined (e.g., via a neural network and/or utilizing one or more machine learning techniques) whether the driver is looking at the one or more object(s).

By way of further illustration, in certain implementations the described technologies can be configured to compute or determine an attentiveness rate, e.g., of the driver. For example, using the monitored gaze direction(s) with known location of the eye(s) and/or reported events from an ADAS system, the described technologies can detect or count instances when the driver looks toward an identified event. Such event(s) can be further weighted (e.g., to reflect their importance) by the distance, direction and/or type of detected events. Such events can include, for example: road signs that do/do not dictate action by the driver, pedestrian standing near or walking along or towards the road, obstacle(s) on the road, animal movement near the road, etc. In certain implementations, the attentiveness rate of the driver can be determined via a neural network and/or utilizing one or more machine learning techniques.

Additionally, in certain implementations the described technologies can be configured to compute or determine the attentiveness of a driver with respect to various in-vehicle reference points/anchors. For example, the attentiveness of the driver with respect to looking at the mirrors of the vehicle when changing lanes, transitioning into junctions/turns, etc. In certain implementations, the attentiveness of the driver can be determined via a neural network and/or utilizing one or more machine learning techniques.

At operation 760, one or more actions can be initiated. In certain implementations, such action(s) can be initiated based on the determination as to whether the driver is looking at the one or more object(s) (e.g., as determined at 750).

In certain implementations, the action(s) can include computing a distance between the vehicle and the one or more objects, computing a location of the object(s) relative to the vehicle, etc.

Moreover, in certain implementations the three-dimensional location of various events, such as those detected/reported by an ADAS can be determined (e.g., via a neural network and/or utilizing one or more machine learning techniques) using/in relation to the determined gaze and/or eye location of the driver. For example, based on the location of an ADAS camera and a determined driver eyes' location, the intersection of respective rays connecting the camera to a detected obstacle and the eyes of the driver to the location to the obstacle can be computed.

In other implementations, the action(s) can include validating a determination computed by an ADAS system.

For example, in certain implementations the measurement of the distance of a detected object (e.g., in relation to the vehicle) can be determined (e.g., via a neural network and/or utilizing one or more machine learning techniques) and further used to validate determinations computed by an ADAS system.

By way of illustration, the gaze of a driver can be determined (e.g., the vector of the sight of the driver while driving). In certain implementations, such a gaze can be determined (e.g., via a neural network and/or utilizing one or more machine learning techniques) using a sensor directed towards the internal environment of the vehicle, e.g., in order to capture image(s) of the eyes of the driver. Data from sensor(s) directed towards the external environment of the vehicle (which include at least a portion of the field of view of the driver while looking outside) can be processed/analyzed (e.g., using computer/machine vision and/or machine learning techniques that may include use of neural networks). In doing so, an object or objects can be detected/identified. Such objects can include objects that may or should capture the attention of a driver, such as road signs, landmarks, lights, moving or standing cars, people, etc. The data indicating the location of the detected object in relation to the field-of-view of the second sensor can be correlated with data related to the driver gaze direction (e.g., line of sight vector) to determine whether the driver is looking at or toward the object. In one example of implementation, geometrical data from the sensors, the field-of-view of the sensors, the location of the driver in relation to the sensors, and the line of sight vector as extracted from the driver gaze detection, can be used to determine that the driver is looking at the object identified or detected from the data of the second sensor.

Having determined that the driver is looking at the object detected based on/in view of the second sensor data, the described technologies can further project or estimate the distance of the object (e.g., via a neural network and/or utilizing one or more machine learning techniques). In certain implementations, such projections/estimates can be computed based on the data using geometrical manipulations in view of the location of the sensors, parameters related to the tilt of the sensor, field-of-view of the sensors, the location of the driver in relation to the sensors, the line of sight vector as extracted from the driver gaze detection, etc. In one example implementation, the X, Y, Z coordinate location of the driver's eyes can be determined in relation to the second sensor and the driver gaze to determine (e.g., via a neural network and/or utilizing one or more machine learning techniques) the vector of sight of the driver in relation to the field-of-view of the second sensor.

The data utilized in extracting the distance of objects from the vehicle (and/or the second sensor) can be stored/maintained further utilized (e.g., together with various statistical techniques) to reduce errors of inaccurate distance calculations. For example, such data can be correlated with the ADAS system data associated with distance measurement of the object the driver is determined to be looking at. In one example of implementation, the distance of the object from the sensor of the ADAS system can be computed, and such data can be used by the ADAS system as a statistical validation to distance(s) measure as determined by the ADAS system.

Additionally, in certain implementations the action(s) can include intervention-action(s) such as providing one or more stimuli such as visual stimuli (e.g. turning on/off or increase light in the vehicle or outside the vehicle), auditory stimuli, haptic (tactile) stimuli, olfactory stimuli, temperature stimuli, air flow stimuli (e.g., a gentle breeze), oxygen level stimuli, interaction with an information system based upon the requirements, demands or needs of the driver, etc.

Intervention-action(s) may further be a different action of stimulating the driver including changing the seat position, changing the lights in the car, turning off, for a short period, the outside light of the car (to create a stress pulse in the driver), creating a sound inside the car (or simulating a sound coming from outside), emulating the sound of the direction of a strong wind hitting the car, reducing/increasing the music in the car, recording sounds outside the car and playing them inside the car, changing the driver seat position, providing an indication on a smart windshield to draw the attention of the driver toward a certain location, providing an indication on the smart windshield of a dangerous road section/turn.

Moreover, in certain implementations the action(s) can be correlated to a level of attentiveness of the driver, a determined required attentiveness level, a level of predicted risk (to the driver, other driver(s), passenger(s), vehicle(s), etc.), information related to prior actions during the current driving session, information related to prior actions during previous driving sessions, etc.

It should be noted that the described technologies may be implemented within and/or in conjunction with various devices or components such as any digital device, including but not limited to: a personal computer (PC), an entertainment device, set top box, television (TV), a mobile game machine, a mobile phone or tablet, e-reader, smart watch, digital wrist armlet, game console, portable game console, a portable computer such as laptop or ultrabook, all-in-one, TV, connected TV, display device, a home appliance, communication device, air-condition, a docking station, a game machine, a digital camera, a watch, interactive surface, 3D display, an entertainment device, speakers, a smart home device, IoT device, IoT module, smart window, smart glass, smart light bulb, a kitchen appliance, a media player or media system, a location based device; and a mobile game machine, a pico projector or an embedded projector, a medical device, a medical display device, a wearable device, an augmented reality enabled device, wearable goggles, a virtual reality device, a location based device, a robot, a social robot, an android, interactive digital signage, a digital kiosk, vending machine, an automated teller machine (ΔTM), a vehicle, a drone, an autonomous car, a self-driving car, a flying vehicle, an in-car/in-air Infotainment system, an advanced driver-assistance system (ADAS), an Occupancy Monitoring System (OMS), any type of device/system/sensor associated with driver assistance or driving safety, any type of device/system/sensor embedded in a vehicle, a navigation system, and/or any other such device that can receive, output and/or process data.

Some portions of the detailed description are presented in terms of algorithms and symbolic representations of operations on data bits within a computer memory. In certain implementations, such algorithms can include and/or otherwise incorporate the use of neural networks and/or machine learning techniques. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “providing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. A computer program to activate or configure a computing device accordingly may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media or hardware suitable for storing electronic instructions.

The present disclosure is not described with reference to any particular programming language. It will be appreciated that a variety of programming languages may be used to implement the teachings of the disclosure as described herein.

As used herein, the phrase “for example,” “such as,” “for instance,” and variants thereof describe non-limiting embodiments of the presently disclosed subject matter. Reference in the specification to “one case,” “some cases,” “other cases,” or variants thereof means that a particular feature, structure or characteristic described in connection with the embodiment(s) is included in at least one embodiment of the presently disclosed subject matter. Thus the appearance of the phrase “one case,” “some cases,” “other cases,” or variants thereof does not necessarily refer to the same embodiment(s).

Certain features which, for clarity, are described in this specification in the context of separate embodiments, may also be provided in combination in a single embodiment. Conversely, various features which are described in the context of a single embodiment, may also be provided in multiple embodiments separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with the accompanying figures are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

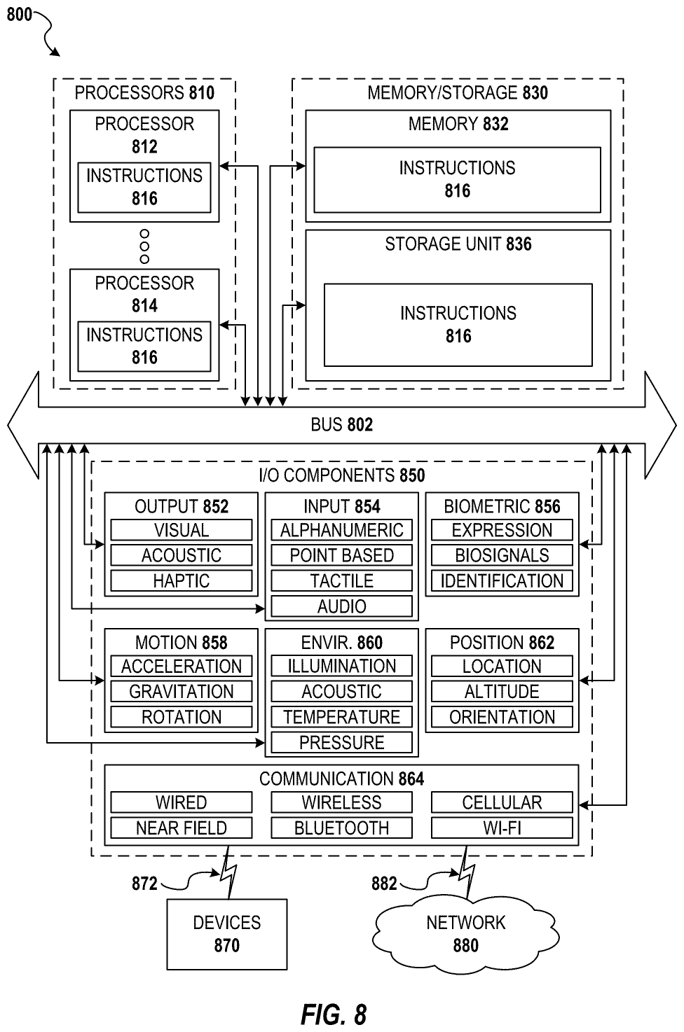

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein can be executed. The instructions 816 transform the general, non-programmed machine into a particular machine programmed to carry out the described and illustrated functions in the manner described. In alternative implementations, the machine 800 operates as a standalone device or can be coupled (e.g., networked) to other machines. In a networked deployment, the machine 800 can operate in the capacity of a server machine or a client machine in a server-client network environment, or as a peer machine in a peer-to-peer (or distributed) network environment. The machine 800 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example implementation, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 812 and a processor 814 that can execute the instructions 816. The term “processor” is intended to include multi-core processors that can comprise two or more independent processors (sometimes referred to as “cores”) that can execute instructions contemporaneously. Although FIG. 8 shows multiple processors 810, the machine 800 can include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions (e.g., instructions 816) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion and the grouping is in no way limiting. In various example implementations, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 850 can include any type of one or more sensor, including biometric components 856, motion components 858, environmental components 860, or position components 862, among a wide array of other components. For example, the biometric components 856 can include components to detect expressions (e.g., hand expressions, facial expressions, vocal expressions, body gestures, or eye tracking), measure biosignals (e.g., blood pressure, heart rate, body temperature, perspiration, or brain waves, pheromone), identify a person (e.g., voice identification, retinal identification, facial identification, fingerprint identification, or electroencephalogram based identification), and the like.

In another example the biometric components 856 can include components to detect biochemical signals of humans such as pheromones, components to detect biochemical signals reflecting physiological and/or psychological stress. The motion components 858 can include acceleration sensor components (e.g., accelerometer), gravitation sensor components, rotation sensor components (e.g., gyroscope), and so forth. The environmental components 860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 862 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 850 can include communication components 864 operable to couple the machine 800 to a network 880 or devices 870 via a coupling 882 and a coupling 872, respectively. For example, the communication components 864 can include a network interface component or other suitable device to interface with the network 880. In further examples, the communication components 864 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 can be another machine or any of a wide variety of peripheral devices (e.g., a peripheral device coupled via a USB).

Moreover, the communication components 864 can detect identifiers or include components operable to detect identifiers. For example, the communication components 864 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 864, such as location via Internet Protocol (IP) geolocation, location via Wi-Fi® signal triangulation, location via detecting an NFC beacon signal that can indicate a particular location, and so forth.

In various example implementations, one or more portions of the network 880 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 880 or a portion of the network 880 can include a wireless or cellular network and the coupling 882 can be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., HTTP). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for contextual driver monitoring according to embodiments and examples described herein.

Example 1 includes a system comprising: a processing device; and a memory coupled to the processing device and storing instructions that, when executed by the processing device, cause the system to perform operations comprising: receiving one or more first inputs; processing the one or more first inputs to determine a state of a driver present within a vehicle; receiving one or more second inputs; processing the one or more second inputs to determine one or more navigation conditions associated with the vehicle, the one or more navigation conditions comprising at least one of: a temporal road condition received from a cloud resource or a behavior of the driver; computing, based on the one or more navigation conditions, a driver attentiveness threshold; and initiating one or more actions in correlation with (A) the state of the driver and (B) the driver attentiveness threshold.

The system of example 1 wherein processing the one or more second inputs to determine one or more navigation conditions comprises processing the one or more second inputs via a neural network.

The system of example 1 wherein processing the one or more first inputs to determine a state of the driver comprises processing the one or more first inputs via a neural network.

The system of example 1, wherein the behavior of the driver comprises at least one of: an event occurring within the vehicle, an attention of the driver in relation to a passenger within the vehicle, one or more occurrences initiated by one or more passengers within the vehicle, one or more events occurring with respect to a device present within the vehicle; one or more notifications received at a device present within the vehicle; one or more events that reflect a change of attention of the driver toward a device present within the vehicle.

The system of example 1, wherein the temporal road condition further comprises at least one of: a road path on which the vehicle is traveling, a presence of one or more curves on a road on which the vehicle is traveling, or a presence of an object in a location that obstructs the sight of the driver while the vehicle is traveling.

The system of example 5, wherein the object comprises at least one of: a mountain, a building, a vehicle or a pedestrian.

The system of example 5, wherein the presence of the object obstructs the sight of the driver with respect to a portion of the road on which the vehicle is traveling.

The system of example 5, wherein the presence of the object comprises at least one of: a presence of the object in a location that obstructs the sight of the driver in relation to the road on which the vehicle is traveling, a presence of the object in a location that obstructs the sight of the driver in relation to one or more vehicles present on the road on which the vehicle is traveling, a presence of the object in a location that obstructs the sight of the driver in relation to an event occurring on the road on which the vehicle is traveling, or a presence of the object in a location that obstructs the sight of the driver in relation to a presence of one or more pedestrians proximate to the road on which the vehicle is traveling.

The system of example 1, wherein computing a driver attentiveness threshold comprises computing at least one of: a projected time until the driver can see another vehicle present on the same side of the road as the vehicle, a projected time until the driver can see another vehicle present on the opposite side of the road as the vehicle, or a determined estimated time until the driver can adjust the speed of the vehicle to account for the presence of another vehicle.

The system of example 1, wherein the temporal road condition further comprises statistics related to one or more incidents that previously occurred in relation to a current location of the vehicle prior to a subsequent event, the subsequent event comprising an accident.

The system of example 10, wherein the statistics relate to one or more incidents that occurred on one or more portions of a road on which the vehicle is projected to travel.

The system of example 10, wherein the one or more incidents comprises at least one of: one or more weather conditions, one or more traffic conditions, traffic density on the road, a speed at which one or more vehicles involved in the subsequent event travel in relation to a speed limit associated with the road, or consumption of a substance likely to cause impairment prior to the subsequent event.

The system of example 1, wherein processing the one or more first inputs comprises identifying one or more previously determined states associated with the driver of the vehicle.

The system of example 1, wherein processing the one or more first inputs comprises identifying one or more previously determined states associated with the driver of the vehicle during a current driving interval.

The system of example 1, wherein the state of the driver comprises one or more of: a head motion of the driver, one or more features of the eyes of the driver, a psychological state of the driver, or an emotional state of the driver.

The system of example 1, wherein the one or more navigation conditions associated with the vehicle further comprises one or more of: conditions of a road on which the vehicle travels, environmental conditions proximate to the vehicle, or presence of one or more other vehicles proximate to the vehicle.

The system of example 1, wherein the one or more second inputs are received from one or more sensors embedded within the vehicle.

The system of example 1, wherein the one or more second inputs are received from an advanced driver-assistance system (ADAS).

The system of example 1, wherein computing a driver attentiveness threshold comprises adjusting a driver attentiveness threshold.

The system of example 1, wherein processing the one or more first inputs comprises processing the one or more first inputs to determine a state of a driver prior to entry into the vehicle.

The system of example 1, wherein processing the one or more first inputs comprises processing the one or more first inputs to determine a state of a driver after entry into the vehicle.

The system of example 1, wherein the state of the driver further comprises one or more of: environmental conditions present within the vehicle, or environmental conditions present outside the vehicle.

The system of example 1, wherein the state of the driver further comprises one or more of: a communication of a passenger with the driver, communication between one or more passengers, a passenger unbuckling a seat-belt, a passenger interacting with a device associated with the vehicle, behavior of one or more passengers within the vehicle, non-verbal interaction initiated by a passenger, or physical interaction directed towards the driver.

The system of example 1, wherein the driver attentiveness threshold comprises a determined attentiveness level associated with the driver.

The system of example 24, wherein the driver attentiveness threshold further comprises a determined attentiveness level associated with one or more other drivers.

Example 26 includes a system comprising:

processing device; and

a memory coupled to the processing device and storing instructions that, when executed by the processing device, cause the system to perform operations comprising:

receiving one or more first inputs;

processing the one or more first inputs to identify a first object in relation to a vehicle;

receiving one or more second inputs;

processing the one or more second inputs to determine, based on one or more previously determined states of attentiveness associated with the driver of the vehicle in relation to one or more objects associated with the first object, a state of attentiveness of a driver of the vehicle with respect to the first object; and

initiating one or more actions based on the state of attentiveness of a driver.

The system of example 26, wherein the first object comprises at least one of: a road sign or a road structure.

The system of example 26, wherein the one or more previously determined states of attentiveness are determined with respect to prior instances within a current driving interval.

The system of example 26, wherein the one or more previously determined states of attentiveness are determined with respect to prior instances within one or more prior driving intervals.

The system of example 26, wherein the one or more previously determined states of attentiveness associated with the driver of the vehicle comprises a dynamic reflected by one or more previously determined states of attentiveness associated with the driver of the vehicle in relation to one or more objects associated with the first object.

The system of example 30, wherein the dynamic reflected by one or more previously determined states of attentiveness comprises at least one of: a frequency at which the driver looks at the first object, a frequency at which the driver looks at a second object, one or more circumstances under which the driver looks at one or more objects, one or more circumstances under which the driver does not look at one or more objects, one or more environmental conditions.

The system of example 26, wherein the one or more previously determined states of attentiveness associated with the driver of the vehicle comprises a statistical model of a dynamic reflected by one or more previously determined states of attentiveness associated with the driver of the vehicle in relation to one or more objects associated with the first object.

The system of example 26, wherein processing the one or more second inputs comprises processing a frequency at which the driver of the vehicle looks at a second object to determine a state of attentiveness of the driver of the vehicle with respect to the first object.

The system of example 26, wherein processing the one or more second inputs to determine a current state of attentiveness comprises: correlating (a) one or more previously determined states of attentiveness associated with the driver of the vehicle and the first object with (b) the one or more second inputs.

The system of any one of examples 26, 30, or 32, wherein at least one of the processing of the first input, the processing of second input, computing driver attentiveness threshold, computing dynamic reflected by one or more previously determined states of attentiveness associated with the driver of the vehicle and the first object or a second object, correlating one or more previously determined states of attentiveness associated with the driver of the vehicle and the first object or a second object is performed via a neural network.

The system of example 26, wherein the state of attentiveness of the driver is further determined in correlation with at least one of: a frequency at which the driver looks at the first object, a frequency at which the driver looks at a second object, one or more driving patterns, one or more driving patterns associated with the driver in relation to navigation instructions, one or more environmental conditions, or a time of day.

The system of example 26, wherein the state of attentiveness of the driver is further determined based on at least one of: a degree of familiarity with respect to a road being traveled, a frequency of traveling the road being traveled, or an elapsed time since a previous instance of traveling the road being traveled.

The system of example 26, wherein the state of attentiveness of the driver is further determined based on at least one of: a psychological state of the driver, a physiological state of the driver, an amount of sleep the driver is determined to have engaged in, an amount of driving the driver is determined to have engaged in, or a level of eye redness associated with the driver.

The system of example 26, wherein the state of attentiveness of the driver is further determined based on information associated with a shift of a gaze of the driver towards the first object.

The system of example 39, wherein the state of attentiveness of the driver is further determined based on information associated with a time duration during which the driver shifts his gaze towards the first object.

The system of example 39, wherein the state of attentiveness of the driver is further determined based on information associated with a motion feature related to a shift of a gaze of the driver towards the first object.

The system of example 26, wherein processing the one or more second inputs comprises: processing (a) one or more extracted features associated with the shift of a gaze of a driver towards one or more objects associated with the first object in relation to (b) one or more extracted features associated with a current instance of the driver shifting his gaze towards the first object, to determine a current state of attentiveness of the driver of the vehicle.

Example 43 includes a system comprising:

a processing device; and

a memory coupled to the processing device and storing instructions that, when executed by the processing device, cause the system to perform operations comprising:

receiving one or more first inputs;

processing the one or more first inputs to identify a first object in relation to a vehicle;

receiving one or more second inputs;

processing the one or more second inputs to determine a state of attentiveness of a driver of the vehicle with respect to the first object, based on (a) a direction of the gaze of the driver in relation to the first object and (b) one or more conditions under which the first object is perceived by the driver; and

initiating one or more actions based on the state of attentiveness of a driver.

The system of example 43, wherein the one or more conditions comprises at least one of: a location the first object in relation to the driver or a distance of the first object from the driver.

The system of example 43, wherein the one or more conditions further comprises one or more environmental conditions including at least one of: a visibility level associated with the first object, a driving attention level, a state of the vehicle, or a behavior of one or more of passengers present within the vehicle.

The system of example 45, wherein the visibility level is determined using information associated with at least one of: rain, fog, snowing, dust, sunlight, lighting conditions associated with the first object.

The system of example 45, wherein the driving attention level is determined using information associated with at least road related information, comprising at least one of: a load associated with the road on which the vehicle is traveling, conditions associated with the road on which the vehicle is traveling, lighting conditions associated with the road on which the vehicle is traveling, sunlight shining in a manner that obstructs the vision of the driver, changes in road structure occurring since a previous instance in which the driver drove on the same road, changes in road structure occurring since a previous instance in which the driver drove to the current destination of the driver, a manner in which the driver responds to one or more navigation instructions.

The system of example 45, wherein behavior of one or more passengers within the vehicle comprises at least one of: a communication of a passenger with the driver, communication between one or more passengers, a passenger unbuckling a seat-belt, a passenger interacting with a device associated with the vehicle, behavior of passengers in the back seat of the vehicle, non-verbal interactions between a passenger and the driver, physical interactions associated with the driver.

The system of example 43, wherein the first object comprises at least one of: a road sign or a road structure.

The system of example 43, wherein the state of attentiveness of the driver is further determined based on at least one of: a psychological state of the driver, a physiological state of the driver, an amount of sleep the driver is determined to have engaged in, an amount of driving the driver is determined to have engaged it, a level of eye redness associated with the driver, a determined quality of sleep associated with the driver, a heart rate associated with the driver, a temperature associated with the driver, or one or more sounds produced by the driver.

The system of example 50, wherein the physiological state of the driver comprises at least one of: a determined quality of sleep of the driver during the night, the number of hours the driver slept, the amount of time the driver is driving over one or more driving during a defined time interval, or how often the driver is used to drive the time duration of the current drive.

The system of example 51, wherein the physiological state of the driver is correlated with information extracted from data received from at least one of: an image sensor capturing image of the driver or one or more sensors that measure physiology-related data, including data related to at least one of: the eyes of the driver, eyelids of the driver, pupil of the driver, eye redness level of the driver as compared to a normal level of eye redness of the driver, muscular stress around the eyes of the driver, motion of the head of the driver, pose of the head of the driver, gaze direction patterns of the driver, or body posture of the driver.

The system of example 43, wherein the psychological state of the driver comprises driver stress.

The system of example 53, wherein driver stress is computed based on at least one of:

extracted physiology related data, data related to driver behavior, data related to events a driver was engaged in during a current driving interval, data related to events a driver was engaged in prior to a current driving interval, data associated with communications related to the driver before a current driving interval, or data associated with communications related to the driver before or during a current driving interval.

The system of example 54, wherein data associated with communications comprises shocking events.

The system of example 53, wherein driver stress is extracted using data from at least one of: the cloud, one or more devices, external services or applications that extract user stress levels.

The system of example 50, wherein the physiological state of the driver is computed based on a level of sickness associated with the driver.

The system of example 57, wherein the level of sickness is determined based on one or more of: data extracted from one or more sensors that measure physiology related data including driver temperature, sounds produced by the driver, a detection of coughing in relation to the driver.

The system of example 57, wherein the level of sickness is determined using data originating from at least one of: one or more sensors, the cloud, one or more devices, one or more external services, or one or more applications, that extract user stress level.

The system of example 43, wherein one or more operations are performed via a neural network.

Example 61 includes a system comprising:

a processing device; and

a memory coupled to the processing device and storing instructions that, when executed by the processing device, cause the system to perform operations comprising:

receiving one or more first inputs from one or more first sensors that collect data within the vehicle;

processing the one or more first inputs to identify a gaze direction of a driver of a vehicle;

receiving one or more second inputs from one or more second sensors that collect data outside the vehicle;

processing the one or more second inputs to determine a location of one or more objects in relation to a field of view of at least one of the second sensors;

correlating the gaze direction of the driver with the location of the one or more objects in relation to the field of view of the at least one of the second sensors to determine whether the driver is looking at at least one of the one or more objects; and

initiating one or more actions based on the determination.

The system of example 61, wherein initiating one or more actions comprises computing a distance between the vehicle and the one or more objects.

The system of example 62, wherein computing the distance comprises computing an estimate of the distance between the vehicle and the one or more objects using at least one of: geometrical manipulations that account for the location of at least one of the first sensors or the second sensors, one or more parameters related to a tilt of at least one of the sensors, a field-of-view of at least one of the sensors, a location of the driver in relation to at least one of the sensors, or a line of sight vector as extracted from the driver gaze detection.

The system of example 62, wherein computing the distance further comprises using a statistical tool to reduce errors associated with computing the distance.

The system of example 61, wherein initiating one or more actions comprises determining one or more coordinates that reflect a location of the eyes of the driver in relation to one or more of the second sensors and the driver gaze to determine a vector of sight of the driver in relation to the field-of-view of the one or more of the second sensors.

The system of example 61, wherein initiating one or more actions comprises computing a location of the one or more objects relative to the vehicle.

The system of example 66, wherein the computed location of the one or more objects relative to the vehicle is provided as an input to an ADAS.

The system of example 61, wherein initiating one or more actions comprises validating a determination computed by an ADAS system.

The system of example 68, wherein processing the one or more first inputs further comprises calculating the distance of an object from a sensor associated with an ADAS system, and using the calculated distance as a statistical validation to a distance measurement determined by the ADAS system.

The system of example 68, wherein validating a determination computed by an ADAS system is performed in relation to one or more predefined objects.

The system of example 70, wherein the predefined objects include traffic signs.

The system of example 70, wherein the predefined objects are associated with criteria reflecting of at least one of: a traffic signs object, an object having a physical size less than a predefined size, an object whose size as perceived by one or more sensors is less than a predefined size, or an object positioned in a predefined orientation in relation to the vehicle

The system of example 72, wherein the predefined orientation of the object in relation to the vehicle relates to objects that are facing the vehicle.

The system of example 70, wherein the determination computed by an ADAS system is in relation to predefined objects.

The system of example 68, wherein validating a determination computed by an ADAS system is in relation to a level of confidence of the system in relation to determined features associated with the driver.

The system of example 75, wherein the determined features associated with the driver include at least one of: a location of the driver in relation to at least one of the sensors, a location of the eyes of the driver in relation to one or more sensors, or a line of sight vector as extracted from a driver gaze detection.

The system of example 68, wherein processing the one or more second inputs further comprises calculating a distance of an object from a sensor associated with an ADAS system, and using the calculated distance as a statistical validation to a distance measurement determined by the ADAS system.

The system of example 61, wherein correlating the gaze direction of the driver comprises correlating the gaze direction with data originating from an ADAS system associated with a distance measurement of an object the driver is determined to have looked at.

The system of example 61, wherein initiating one or more actions comprises providing one or more stimuli comprising at least one of: visual stimuli, auditory stimuli, haptic stimuli, olfactory stimuli, temperature stimuli, air flow stimuli, or oxygen level stimuli.

The system of example 61, wherein the one or more actions are correlated to at least one of: a level of attentiveness of the driver, a determined required attentiveness level, a level of predicted risk, information related to prior actions during the current driving session, or information related to prior actions during other driving sessions.

The system of example 61, wherein one or more operations are performed via a neural network.

The system of example 61, wherein correlating the gaze direction of the driver comprises correlating the gaze direction of the driver using at least one of: geometrical data of at least one of the first sensors or the second sensors, a field-of-view of at least one of the first sensors or the second sensors, a location of the driver in relation to at least one of the first sensors or the second sensors, a line of sight vector as extracted from the detection of the gaze of the driver.

The system of example 61, wherein correlating the gaze direction of the driver to determine whether the driver is looking at at least one of the one or more objects further comprises determining that the driver is looking at least one of the one or more objects that is detected from data originating from the one or more second sensors.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving one or more first inputs;
processing the one or more first inputs to identify a first object in relation to a vehicle;
receiving one or more second inputs;
processing the one or more second inputs to determine a state of attentiveness of a driver of the vehicle with respect to the first object, based on (a) a direction of the gaze of the driver in relation to the first object and (b) one or more conditions under which the first object is perceived by the driver; and
initiating one or more actions based on the state of attentiveness of a driver.

2. The system of claim 1, wherein the one or more conditions comprises at least one of: a location the first object in relation to the driver or a distance of the first object from the driver.

3. The system of claim 1, wherein the one or more conditions further comprises one or more environmental conditions including at least one of: a visibility level associated with the first object, a driving attention level, a state of the vehicle, or a behavior of one or more of passengers present within the vehicle.

4. The system of claim 3, wherein the driving attention level is determined using information associated with at least road related information, comprising at least one of: a load associated with the road on which the vehicle is traveling, conditions associated with the road on which the vehicle is traveling, lighting conditions associated with the road on which the vehicle is traveling, sunlight shining in a manner that obstructs the vision of the driver, changes in road structure occurring since a previous instance in which the driver drove on the same road, changes in road structure occurring since a previous instance in which the driver drove to the current destination of the driver, a manner in which the driver responds to one or more navigation instructions.

5. The system of claim 3, wherein behavior of one or more passengers within the vehicle comprises at least one of: a communication of a passenger with the driver, communication between one or more passengers, a passenger unbuckling a seat-belt, a passenger interacting with a device associated with the vehicle, behavior of passengers in the back seat of the vehicle, non-verbal interactions between a passenger and the driver, physical interactions associated with the driver.

6. The system of claim 1, wherein the first object comprises at least one of: a road sign, a road structure, a vehicle, a human, an animal, a road construction, an object present on the road, an object present within the vehicle, or an object present in the vicinity of the vehicle.

7. The system of claim 1, wherein the state of attentiveness of the driver is further determined based on at least one of: a psychological state of the driver, a physiological state of the driver, an amount of sleep the driver is determined to have engaged in, an amount of driving the driver is determined to have engaged it, a level of eye redness associated with the driver, a determined quality of sleep associated with the driver, a heart rate associated with the driver, a temperature associated with the driver, or one or more sounds produced by the driver.

8. The system of claim 7, wherein the physiological state of the driver comprises at least one of: a determined quality of sleep of the driver during the night, the number of hours the driver slept, the amount of time the driver is driving over one or more driving during a defined time interval, or how often the driver is used to drive the time duration of the current drive.

9. The system of claim 8, wherein the physiological state of the driver is correlated with information extracted from data received from at least one of: an image sensor capturing image of the driver or one or more sensors that measure physiology-related data, including data related to at least one of: the eyes of the driver, eyelids of the driver, pupil of the driver, eye redness level of the driver as compared to a normal level of eye redness of the driver, muscular stress around the eyes of the driver, motion of the head of the driver, pose of the head of the driver, gaze direction patterns of the driver, or body posture of the driver.

10. The system of claim 7, wherein the psychological state of the driver comprises driver stress.

11. The system of claim 10, wherein driver stress is computed based on at least one of: extracted physiology related data, data related to driver behavior, data related to events a driver was engaged in during a current driving interval, data related to events a driver was engaged in prior to a current driving interval, data associated with communications related to the driver before a current driving interval, data associated with communications related to the driver before or during a current driving interval, wherein data associated with communications comprises shocking events.

12. The system of claim 10, wherein driver stress is extracted using data from at least one of: the cloud, one or more devices, external services or applications that extract user stress levels.

13. The system of claim 7, wherein the physiological state of the driver is computed based on a level of sickness associated with the driver.

14. The system of claim 1, wherein at least one of the processing the one or more first inputs to identify a first object in relation to a vehicle, the processing the one or more second inputs to determine a state of attentiveness of a driver of the vehicle with respect to the first object, based on (a) a direction of the gaze of the driver in relation to the first object and (b) one or more conditions under which the first object is perceived by the driver; or the initiating one or more actions based on the state of attentiveness of a driver, are performed via a neural network.

15. A method comprising:
receiving one or more first inputs;
processing the one or more first inputs to identify a first object in relation to a vehicle;
receiving one or more second inputs;
processing the one or more second inputs to determine a state of attentiveness of a driver of the vehicle with respect to the first object, based on (a) a direction of the gaze of the driver in relation to the first object and (b) one or more conditions under which the first object is perceived by the driver; and
initiating one or more actions based on the state of attentiveness of a driver.

16. The method of claim 15, wherein the one or more conditions further comprises one or more environmental conditions including at least one of: a visibility level associated with the first object, a driving attention level, a state of the vehicle, or a behavior of one or more of passengers present within the vehicle.

17. The method of claim 16, wherein the driving attention level is determined using information associated with at least road related information, comprising at least one of: a load associated with the road on which the vehicle is traveling, conditions associated with the road on which the vehicle is traveling, lighting conditions associated with the road on which the vehicle is traveling, sunlight shining in a manner that obstructs the vision of the driver, changes in road structure occurring since a previous instance in which the driver drove on the same road, changes in road structure occurring since a previous instance in which the driver drove to the current destination of the driver, a manner in which the driver responds to one or more navigation instructions.

18. The method of claim 17, wherein at least one of the processing the one or more first inputs to identify a first object in relation to a vehicle, the processing the one or more second inputs to determine a state of attentiveness of a driver of the vehicle with respect to the first object, based on (a) a direction of the gaze of the driver in relation to the first object and (b) one or more conditions under which the first object is perceived by the driver; or the initiating one or more actions based on the state of attentiveness of a driver, are performed via a neural network.

19. The method of claim 16, wherein behavior of one or more passengers within the vehicle comprises at least one of: a communication of a passenger with the driver, communication between one or more passengers, a passenger unbuckling a seat-belt, a passenger interacting with a device associated with the vehicle, behavior of passengers in the back seat of the vehicle, non-verbal interactions between a passenger and the driver, physical interactions associated with the driver.

20. The method of claim 15, wherein the state of attentiveness of the driver is further determined based on at least one of: a psychological state of the driver, a physiological state of the driver, an amount of sleep the driver is determined to have engaged in, an amount of driving the driver is determined to have engaged it, a level of eye redness associated with the driver, a determined quality of sleep associated with the driver, a heart rate associated with the driver, a temperature associated with the driver, or one or more sounds produced by the driver.

21. The method of claim 20, wherein the physiological state of the driver is correlated with information extracted from data received from at least one of: an image sensor capturing image of the driver or one or more sensors that measure physiology-related data, including data related to at least one of: the eyes of the driver, eyelids of the driver, pupil of the driver, eye redness level of the driver as compared to a normal level of eye redness of the driver, muscular stress around the eyes of the driver, motion of the head of the driver, pose of the head of the driver, gaze direction patterns of the driver, or body posture of the driver.

22. A non-transitory computer readable medium having instructions stored thereon that, when executed by a processing device, cause the processing device to perform operations comprising:
receiving one or more first inputs;
processing the one or more first inputs to identify a first object in relation to a vehicle;
receiving one or more second inputs;
processing the one or more second inputs to determine a state of attentiveness of a driver of the vehicle with respect to the first object, based on (a) a direction of the gaze of the driver in relation to the first object and (b) one or more conditions under which the first object is perceived by the driver; and
initiating one or more actions based on the state of attentiveness of a driver.
